(19) United States
(12) Patent Application Publication
(10) Pub. No.: US 2010/0153312 A1
(43) Pub. Date: Jun. 17, 2010

(54) SOLAR HEATING SYSTEM, STORAGE TANK FOR USE THEREIN, METHOD OF MANUFACTURING SOLAR COLLECTION PANEL FOR USE THEREIN, AND METHOD OF INSTALLING THE SAME

(75) Inventor: Auguste Lemaire, Reno, NV (US)

Correspondence Address: HOLLAND & HART, LLP, P.O BOX 8749, DENVER, CO, 80201, US

(73) Assignee: Auguste Lemaire, Reno, NV (US)

(21) Appl. No.: 12/630,721

(22) Filed: Dec. 3, 2009

Related U.S. Application Data
(63) Continuation-in-part of application No. 12/327,662, filed on Dec. 3, 2008.

(51) Int. Cl. G06Q 90/00; F24J 2/30; F24J 2/04; F24J 2/24; F24J 2/48; B23P 15/26; B23P 19/04; E04D 13/18

(52) U.S. Cl. 705/500; 126/643; 126/679; 126/663; 126/677; 126/640; 29/890.033; 29/700; 126/621

(57) ABSTRACT

The present disclosure is directed to solar heating systems, storage tanks with heat exchanger that may be used in a solar heating system, methods of constructing solar collection panels, methods of installing solar collection panels, methods of manufacturing and selling solar heat exchange systems, and methods of distributing solar heat exchange system manufacturing facilities. The solar collection panels and heat exchangers may comprise envelope-type configurations wherein one or more dimples are formed in an exterior surface of the solar collection panels or the heat exchangers. The solar collection panels and heat exchangers may have a variety of different shapes and sizes, and may be colored, such as by painting the solar collection panels or heat exchangers. Manufacturing facilities for manufacturing solar collection panels, heat exchangers and other components of solar heat exchange systems may be distributed to third parties assigned to designated areas by providing the third parties with the information and equipment needed to establish micro-factories.

### RELATED APPLICATION

This application is a continuation in part of, and claims priority through, the applicant's prior U.S. Non-Provisional patent application Ser. No. 12/327,662, filed Dec. 3, 2008, which is incorporated by reference herein.

### FIELD OF THIS DISCLOSURE

The present disclosure relates to solar heating systems. This disclosure also relates to solar collection panels and various ways and aspects of methods of making, using, and otherwise distributing such panels.

### BACKGROUND

Traditional fluid-heating solar collection panels often include tubes arranged in parallel and adapted to contain heat exchange fluid running through them. As shown in FIG. 1, the tubes 1 of one such solar collection panel 10 are housed between opposing plates 2, 3 and connected at their ends to manifolds 4, 5. The manifolds 4, 5 serve to distribute heat exchange fluid traveling to the solar collection panel 10 among the several tubes 1 at one end and to collect and carry away heat exchange fluid that has passed through the tubes 1 at an opposite end.

One disadvantage of this configuration is the amount of heat transfer between the plate surface and the heat exchange fluid passing through the tubes. Commonly, the tubes must be in contact with the plate surface in order to effect heat transfer from the plate to the tubes and then from the tubes to the heat exchange fluid within the tubes. In addition, because the tubes are typically either cylindrical or “D” shaped, the heat transfer surface between the plate surface and tubes is limited as is the amount of heat transfer between the plates and the fluid running through the tubes.

In many traditional such solar collection panels, the solar absorption and other plating is made of copper. Use of copper can restrict techniques for making the solar collection panels. Furthermore, copper often does not possess the required strength needed to construct a solar collection panel having an irregular shape that might be used to help a solar collection panel blend into the structure on which it is assembled. Additionally, the traditional pipe and manifold configuration of a non-voltaic solar collection panel has typically constrained the shape of the solar collection panel to rectangular and similar shapes.

These types of solar collection panels also typically operate at high surface temperatures, which results in high levels of re-radiation from the solar collection panel surface. In order to cut down on re-radiation, panel surfaces are often coated with coatings of materials such as, for example, absorptive black material treated with chromium dioxide, but these coatings are commonly expensive to implement and also limit the color and aesthetic appearance of the solar collection panels. Even when not so coated, the panels in these types of systems are typically highly restricted in available color, sometimes in order to maximize heating of the panel in view of other relatively inefficient structures or methods of operation of the panel such as, among others, those noted above.

When used to heat water retained in a water storage tank, traditional solar heating systems 20 typically employ a solar collection panel 21 as described above in fluid communication with a coiled heat exchanger 22 disposed inside the storage tank 23. This configuration is illustrated in FIG. 2, and in this configuration the heat exchanger 22 has a relatively small surface area for transferring heat to water passing around the coiled heat exchanger 22 in the water storage tank 23.

Traditional solar panel, storage tank, and related construction techniques have also been cumbersome, expensive, and difficult to transport. Accordingly, business models for providing such techniques or their resulting products have been limited.

### SUMMARY

Some embodiments of the present disclosure include a solar collection panel having two opposed sides, dimples, depressions, or structures formed or installed in or to at least one of the opposed sides and in contact with the other of the opposed sides, and one or more heat transfer fluid flow channels penetrating the opposed sides, with the opposed sides and one or more heat transfer fluid flow channels cooperatively providing a heat transfer fluid flow chamber. One or more portions of sides of the panel also constitute solar energy absorption materials.

In some embodiments, the one or more sides of the panel are made of steel—in some embodiments, stainless steel. In some embodiments, the solar panel, or at least one or more solar absorption panel portions, are paintable or treatable to yield a plurality differing colors as desired—in some embodiments, widely differing colors to match aesthetic objectives for the solar panel.

In some embodiments, the panel includes at least a first heat transfer fluid flow channel penetrating one edge of the panel and a second heat transfer fluid flow channel and the opposing or other edge of the panel. In some embodiments, one or more of fluid flow channels are formed in, and cooperatively provided by, one or more sections of the sides of the panel.

In some embodiments, the solar panel can be formed in a wide variety of shapes rectangular, triangular, etc.

In some embodiments, the solar panel is mounted in a panel frame, a solar lens is mounted in the frame spaced from the solar panel, and an insulation material is mounted on or adjacent the side of the solar panel opposite the side facing the solar lens. The insulation material includes a material that yields relatively little off-gas when used in the solar panel. Other materials or structures may be mounted within the panel frame to secure the position of the solar panel with respect to one or more other structures or materials, such as for example the insulation material.

Other aspects of the present disclosure involve a solar heating system providing a solar collection panel for heating fluid in an associated fluid-containment vessel, such as a fluid storage tank for example. A solar panel envelope may be mounted to or comprise a section of a side wall in the fluid containment vessel. In some embodiments the fluid transfer channels or piping may be formed integrally in or to the solar collection panel. In some embodiments, the solar panel envelope may extend along the length of the fluid-containment vessel. In some embodiments in which the heat exchanger or envelope is utilized as a portion of the fluid-containment vessel side wall, the heat exchanger or envelope can serve as a direct heat exchanger from the heat exchanger or envelope to, for example, fluid contained inside the tank.

The fluid containment vessel can, in some embodiments, contain potable water. In certain embodiments, the solar heating system utilizes propylene glycol as the heat transfer fluid for circulation within the solar collection panel and associated fluid transfer channels or piping if any.

In some embodiments, the solar heating system may utilize a heat transfer fluid pump or thermal siphon. In some embodiments, such a pump may run on 120V AC current (or other types of current, such as DC current provided by a photovoltaic cell or panel) and, if desired, controlled by a differential thermostat.

In some embodiments, heat exchange fluid can rise through the heat exchange fluid envelope or other cavity as it is heated and sink as it cools, thus creating a thermal siphon. In some embodiments, this type of fluid cycling can reduce or avoid heat exchange fluid back flow in a fashion that would remove heat transferred into the material heated within the storage tank.

Some aspects of the present disclosure include machinery that may be used to, among other things, manufacture solar panels. In some embodiments, one such machine is a compact, portable, or economical seam welder adaptable to adjust the location and rotate one or more opposing seam welding wheels, to seam weld two metal sections for example. In some embodiments, the seam welder utilizes relatively low voltage to provide seam welds.

In some embodiments, another such machine is a relatively compact, portable, or economical spot welder, to yield spot welds two metal sections for example. In some embodiments, the spot welder utilizes relatively low voltage to provide seam welds.

Other embodiments of the instant disclosure relate to a method of constructing a solar collection panel. In some embodiments, the method may comprise a first step of providing a first sheet of material having a first side edge, a second side edge opposite the first side edge, a first end, a second end opposite the first end, and a central portion surrounded by the first side edge, second side edge, first end and second end. Another step of the method may comprise forming one or more dimples in the central portion of the first sheet of material. Another step of the method may comprise the step of providing a second sheet of material having a first edge, a second edge opposite the first edge, a first end and a second end opposite the first end. Another step of the method may comprise crimping the first edge and the second edge of the second sheet of material to thereby create a second sheet of material having a valley between the first and second crimped edges. Another step of the method may comprise aligning the first sheet of material with the second sheet of material. The two sheets of material may be aligned so that the one or more dimples in the first sheet of material protrude into the valley of the second sheet of material and the crimped first and second edges of the second sheet of material contact the first side and second side edges of the first sheet of material, respectively.

Another step of the method may comprise spot welding the one or more dimples in the first sheet of material to the valley of the second sheet of material. In some embodiments, this can be accomplished with one or more specialized or other resistance welders, which can, in some embodiments, reduce manufacturing costs, labor, or time.

Another step of the method may comprise seam welding the first side edge of the first sheet of material to the first edge of the second sheet of material and seam welding the second side edge of the first sheet of material to the second edge of the second sheet of material. In some embodiments, this can be accomplished with one or more specialized or other seam welders, which can, in some embodiments, reduce manufacturing costs, labor, or time.

Another step of the method may comprise form molding the first end of the first sheet of material and the first end of the second sheet of material to form a first manifold and form molding the second end of the first sheet of material and the second end of the second sheet of material to form a second manifold. Another step of the method may comprise seam welding the first end of the first sheet of material to the first end of the second sheet of material and seam welding the second end of the first sheet of material to the second end of the second sheet of material. This step can, in some embodiments, use the same seam welder(s) noted above.

Certain embodiments of the instant disclosure relate to the solar collection panel and system manufactured by one or more of the methods described above or other methods disclosed herein. The panel system may also include, in some embodiments:

(i) a lens (such as tempered glass in some embodiments) mounted adjacent, but in some embodiments separated from, the solar collector and that may allow sun exposure and/or prevent ambient air or environmental circumstances from transferring heat from the solar collector or envelope surface;
(ii) a rigid frame, such as made of angle iron, aluminum, or steel, for example, adhered to the lens, which can, in some embodiments, provide one more among support for the lens, sealing air between the lens and solar collection panel, and protecting the glass;
(iii) a frame support structure, such as wood support structure, to which the rigid frame may be mounted, and which may be secured to yet underlying structure (such as a roof or other frame as but one example); the frame support structure may also help maintain separation between, or desired orientation with respect to, the lens and the solar collector;
(iv) a solar collector envelope spaced from the lens and that may or may not have a fluid distribution manifold and with the solar facing or other structure painted to increase solar absorption and/or provide aesthetic appeal, particularly as compared to adjacent structures or landscape;
(iv) insulation on or adjacent the side of the solar collector opposite the solar energy collecting side to, in some embodiments, reduce or prevent undesired heat loss from or exchange with the solar collector and, for example, ambient air or the underlying or other structure.

Certain embodiments of the instant disclosure involve a method of installing solar collection panels on a structure. In some embodiments, the method may comprise a step of selecting a location on a structure on which to erect a solar collection panel. Another step of the method may comprise assembling a solar collection panel. The solar collection panel may comprise a first sheet of material having peripheral edges and a central portion surrounded by the peripheral edges, wherein the central portion protrudes below the peripheral edges to create a valley in the first sheet of material. The solar collection panel may also comprise a second sheet of material having peripheral edges and a central portion surrounded by the peripheral edges. The central portion of the second sheet of material may comprise one or more dimples. The peripheral edges of the first sheet of material may be aligned with the peripheral edges of the second sheet of material such that dimples in the second sheet of material extend into the valley in the first sheet of material. The method may also comprise a step of installing the solar collection panel on the structure such that the second sheet of material faces away from the structure. Another step of the method may comprise changing the color of the second sheet of material of the solar collection panel.

Certain embodiments of the instant disclosure comprise a method of manufacturing and selling solar heat exchange systems. In some embodiments, the method may comprise a step of establishing or providing one or more micro-factories or sets of facilities that may be equipped to manufacture, install, use, distribute, or sell solar heat exchange systems. The micro-factories, or providing of micro-factories or facilities, may include limitations to servicing only customers residing within a pre-determined territory. Another step of the method may comprise each one of the micro-factories receiving custom orders for solar heat exchange systems from customers within each micro-factory's pre-determined territory. Another step of the method may comprise each of the micro-factories ordering and receiving raw materials for custom-ordered solar heat exchange systems from an identical raw materials supply source. Another step of the method may comprise each of the micro-factories manufacturing the custom-ordered solar heat exchange systems. Another step of the method may comprise each of the micro-factories selling the custom-ordered solar heat exchange systems to the customers within its pre-determined territory.

In certain embodiments, a method of distributing solar heat exchange system manufacturing facilities may comprise a step of gathering manufacturing equipment for manufacturing solar heat exchange systems. The manufacturing equipment may include a dimpler, a crimper, a spot welder, a seam welder, and manifold form molds. The method may further comprise gathering information on the manufacture of solar heat exchange systems using the manufacturing equipment. The method may also comprise a step of distributing the manufacturing equipment and information to a third party. The third party may be located in a local region. The third party also may manufacture the solar collection systems and use, distribute, or sell them in conjunction with other products or facilities. Some other such products or facilities can include, as examples, one or more water storage tanks, pumps, thermal siphoning apparatus, or buildings or houses. The manufacturing operation my include the capability of manufacturing storage tanks, mounting hardware, pumps, pump controls, photovoltaic collectors, or any other associated products or structures, some which may operate in conjunction or in tandem with a solar panel system.

Features from any of the above mentioned embodiments may be used in combination with one another, without limitation. In addition, there are other embodiments, features, and advantages of embodiments disclosed herein; they will become apparent to those of ordinary skill in the art through consideration of the ensuing description, the accompanying drawings, and the appended claims.

In this regard, this Summary and the prior Background are not to be considered as limiting, and thus the scope of the invention is to be determined by the scope of the claims as issued and not by whether a given feature is recited in this Summary or addresses any issue or consideration recited in the Background.

### BRIEF DESCRIPTION OF THE DRAWINGS

The preferred and other embodiments are disclosed in association with the accompanying drawings in which:

FIG. 1 illustrates a perspective view of a solar collection panel as known in the art.

FIG. 2 illustrates a perspective view of a storage tank with coiled heat exchanger as known in the art.

FIG. 3 illustrates a perspective view of a solar heating system according to an embodiment disclosed herein.

FIG. 4A-1 illustrates a cross-sectional view of a solar collection panel as may be used in the solar heating system illustrated in FIG. 3.

FIG. 4A-2 illustrates a cross-sectional view of a solar collection panel as may be used in the solar heating system illustrated in FIG. 3.

FIG. 4B illustrates a perspective plan view of a solar collection panel as may be used in the solar heating system illustrated in FIG. 3.

FIG. 4C illustrates a cross-section view of a solar collection panel having fittings as may be used in the solar heating system illustrated in FIG. 3.

FIG. 5 illustrates a partially cut-away perspective view of a storage tank having an integrated heat exchanger according to an embodiment disclosed herein.

FIG. 6 illustrates a flow diagram of a method of manufacturing a solar collection panel according to an embodiment disclosed herein.

FIG. 7 illustrates a perspective view of a dimpler that may be used in a method of making solar collection panels described herein.

FIG. 8 illustrates a perspective view of a crimped sheet of material for use in manufacturing a solar collection panel according to an embodiment disclosed herein.

FIG. 9 illustrates a perspective view of a crimper that may be used in a method of manufacturing solar collection panels described herein.

FIG. 10 illustrates a spot welder that may be used in a method of manufacturing solar collection panels described herein.

FIG. 10A illustrates components of the spot welder or FIG. 10;

FIGS. 11A-C (C taken along section line E-E of B) illustrate a seam welder that may be used in a method of manufacturing solar collection panels described herein.

FIG. 12 illustrates a form molding apparatus that may be used in a method of manufacturing solar collection panels described herein.

FIG. 13 illustrates a flow diagram of a method of installing a solar collection panel according to an embodiment disclosed herein.

FIG. 14 illustrates a perspective view of a structure having shaped solar collection panels formed thereon in accordance with an embodiment disclosed herein.

FIG. 15 illustrates a perspective view of a structure having shaped solar collection panels formed thereon in accordance with an embodiment disclosed herein.

FIG. 16 illustrates a flow diagram of a method of manufacturing, using, distributing, and selling solar collection panel according to an embodiment disclosed herein.

FIG. 17 illustrates a flow diagram of a method of distributing solar collection panel manufacturing facilities according to an embodiment disclosed herein.

FIGS. 18A-D illustrate one embodiment of a rectangular solar panel collection assembly.

FIGS. 19A-B (B taken along section GG of B) illustrate an alternative embodiment of a rectangular solar panel assembly.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

A first embodiment of the instant disclosure relates to a solar heating system. While the solar heating system may be used for a variety of applications, one specific application envisioned herein is the heating of water stored in a storage tank for residential use.

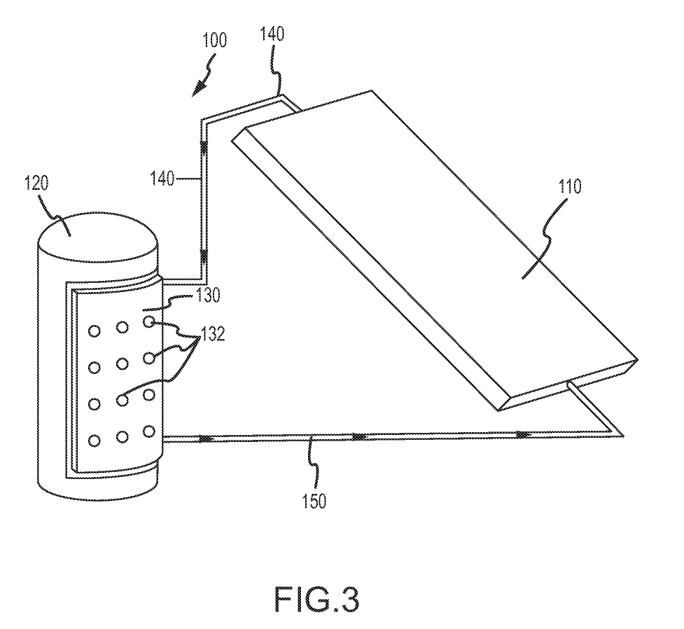

As shown in FIG. 3, the solar heating system 100 may generally comprise a solar collection panel 110, a fluid-containment vessel 120, a heat exchanger wall 130, a first set of piping 140, and a second set of piping 150. A heat exchanger wall 130 may be mounted to the side of the fluid-containment vessel 120, while solar collection panel 110 may be separated from fluid-containment vessel 120 and heat exchanger wall 130. Alternatively, the heat exchanger wall 130 may constitute a solar collector panel, and in this regard, in some embodiments this can allow use of a fluid containment vessel with integrated solar collection panel/heat exchanger wall but without necessarily including or using other structure, such as a separate solar collection panel 110, in order to heat fluid in the fluid containment vessel 120.

In some embodiments, a heat exchanger wall 131 may extend around the entire circumference of the fluid-containment vessel 120. Alternatively, or in addition, a solar collector/heat exchanger wall 131 also may extend along the full length the fluid-containment vessel or tank 120. Extending the solar collector/heat exchanger wall 121 along the length or the tank 120 can increase the solar collection rate of the wall 121 as well as allow for greater circulation of heat transfer media, such as a solution, within solar collector/heat exchanger wall 131. In some embodiments, this structure can provide hot water for an associated home, for example, all day long, even on a cloudy day.

Alternatively or in addition, a heat exchanger structure or envelope may be mounted inside the tank 120. This heat exchanger structure can include one or move heat exchanger envelopes that may be, if desired, in fluid communication with an external solar collector, such as a solar collection panel, heat exchanger wall, or solar collector/heat exchanger wall.

A first set of piping 140 and second set of piping 150 may provide fluid communication between solar collection panel 110 and heat exchanger wall 130 to thereby create a fluid loop allowing fluid to travel throughout solar heating system 100.

In operation, fluid passing through solar collection panel 110 may be heated by solar energy. The heated fluid leaving solar collection panel 110 may travel via first set of piping 140 to heat exchanger wall 130. Heat exchanger wall 130 may be positioned on fluid-containment vessel 120 so as to create a gap between heat exchanger wall 130 and fluid-containment vessel 120 through which heated fluid may pass. As the heated fluid passes between the outer wall of the fluid-containment vessel 120 and heat exchanger wall 130, heat from the heated fluid passes into fluid-containment vessel to heat the water contained therein. Upon transferring its heat to the water inside fluid-containment vessel 120, the fluid leaves the gap between fluid-containment vessel 120 and heat exchanger wall 130 and travels back towards solar collection panel 110 via second set of piping 150. Upon return to solar collection panel 110, the fluid is reheated by solar energy and begins the loop again.

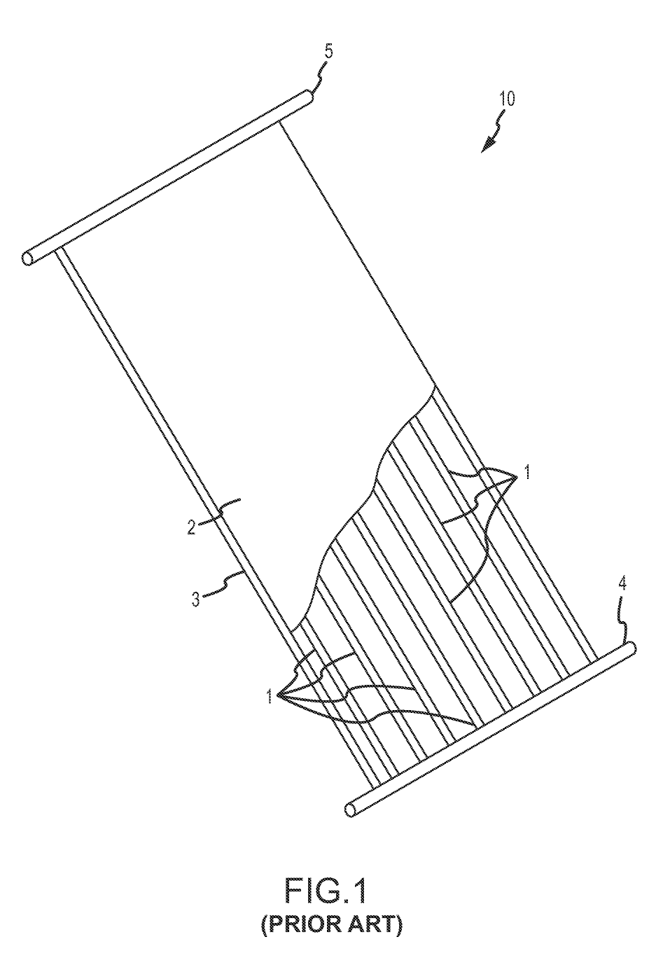

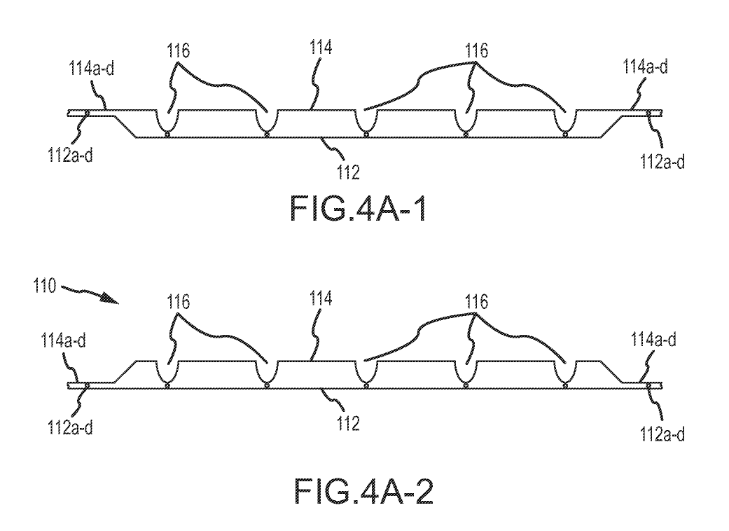

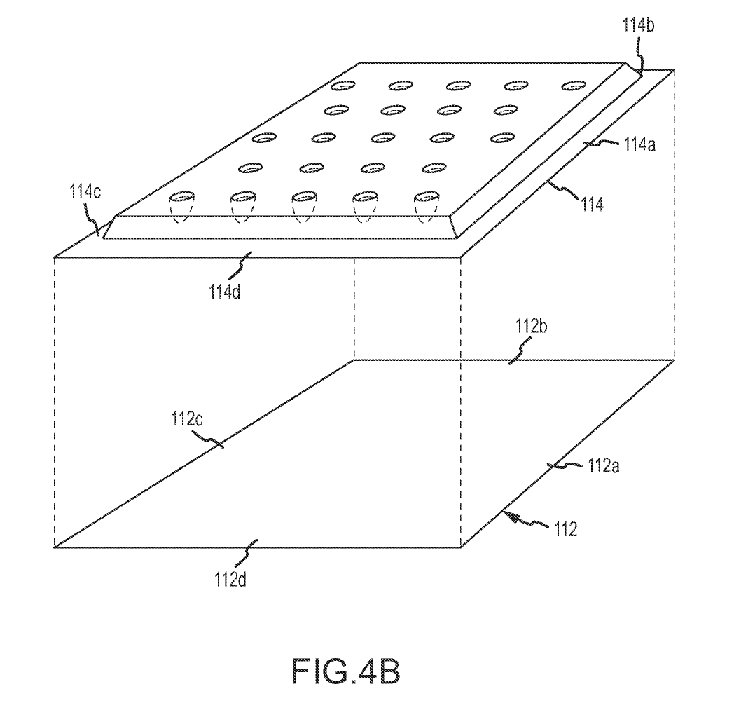

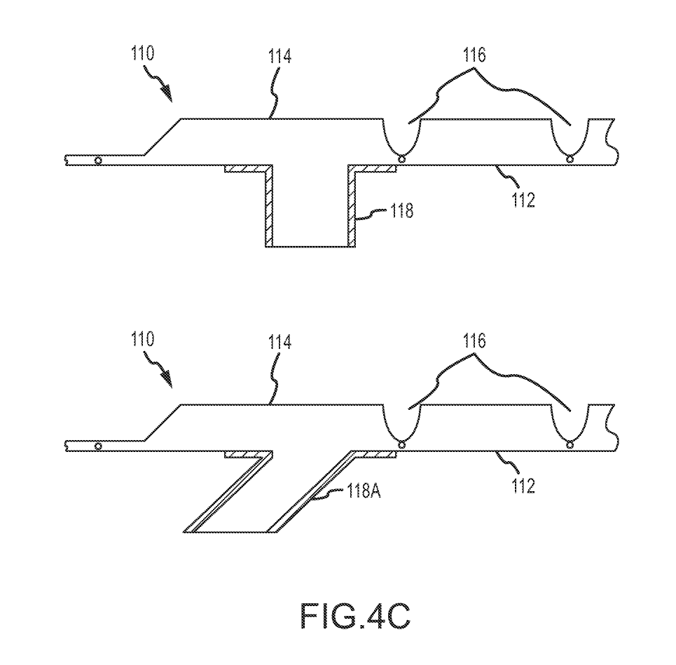

Solar collection panel 110 may be any suitable solar collection panel capable of collecting solar energy and transferring heat to a fluid running therethrough. In one specific aspect of this embodiment, solar collection panel 110 comprises an envelope-type solar collection panel. As shown in FIGS. 4A-1 and 4A-2, such a solar collection panel may generally comprise a first sheet of material 112 and a second sheet of material 114. The first sheet of material 112 and second sheet of material 114 may be aligned in parallel, approximately equal in size, adjoined at the peripheral edges, and second sheet of material 114 may have one or more dimples 116 formed therein. The shape and dimensions of first sheet of material 112 and second sheet of material 114 are not limited. As shown in FIG. 4B, first sheet of material 112 and second sheet of material 114 have a rectangular shape. First sheet of material 112 and second sheet of material 114 could also have a circular shape, a triangular shape, or a polygon having any number of sides. The shape of first sheet of material 112 and second sheet of material 114 may also have a regular polygon shape or an irregular polygon shape.

First sheet of material 112 and second sheet of material 114 may also be colored. Coloring of first sheet of material 112 and second sheet of material 114 may be by any suitable means, such as by painting, plating, or dyeing. In the case of painting, any type of commercially available paint, such as Glidden™, Behr™ or Benjamin Moore™ may be used. First sheet of material 112 and second sheet of material 114 may also be changed to any color. For example, first sheet of material 112 and second sheet of material 114 may be colored red, orange, yellow, green, blue, indigo or violet, or any shade thereof. In one aspect, the color is a dark shade of one of the previously mentioned colors. Coloring first sheet of material 112 and second sheet of material 114 will not drastically alter the efficiency (i.e., only an approximately 10-12% reduction in efficiency) of solar collection panel 110 formed therefrom. Accordingly, solar collection panel 110 may be colored in such a way as to blend in to the structure upon which solar collection panel 110 is mounted or to blend in with the surroundings where solar collection panel 110 is mounted.

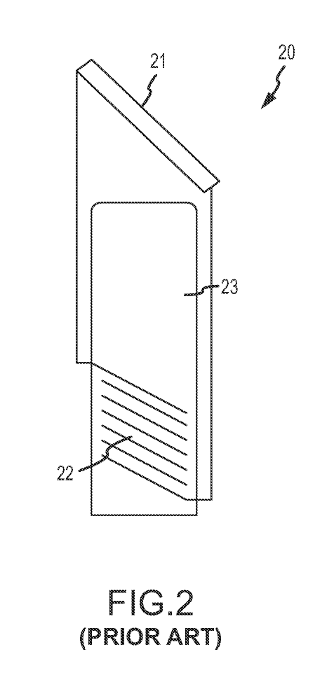

As shown in FIG. 4B, first sheet of material 112 may first have peripheral edges 112a, 112b, 112c and 112d and second sheet of material 114 may have peripheral edges 114a, 114b, 114c, and 114d. Peripheral edges 114a-114d of second sheet of material 114 may serve as the boundaries for a central portion 114e. Central portion 114e may protrude away from peripheral edges 114a-114d. When peripheral edges 112a-112d are secured to peripheral edges 114a-114d, a void space is created between the first sheet of material 112 and the second sheet of material 114 by virtue of the raised central portion 114e. This configuration is shown in FIG. 4A-2. Alternatively, peripheral edges 114a-114d of second sheet of material 114 may be flat, while peripheral edges 112a-112d of first sheet of material 112 may be bent upwardly and surround a central portion that protrudes away from peripheral edges 112a-112d. Such an alternative configuration is shown in FIG. 4A-1.

Peripheral edges 112a-112d may be secured to peripheral edges 114a-114d by any suitable means, and in one aspect of this embodiment, peripheral edges 112a-112d are secured to peripheral edges 114a-114d by welding. The welding may be resistance welding. As shown in FIGS. 4A-2 and 4B, peripheral edges 114a-114d may be bent towards peripheral edges 112a-112d so that welding can take place to form the void space. However, as discussed above and as shown in FIG. 4A-1, it is also possible that peripheral edges 112a-112d of first sheet of material 112 may be bent towards the peripheral edges 114a-114d of second sheet of material, which are flat. It is also possible that both peripheral edges 112a-112d and peripheral edges 114a-114d may be bent towards each other for seam welding (see exemplary seam welding discussion below).

Dimples 116 in second sheet of material 114 may extend towards first sheet of material 112. In other words, dimples 116 may extend into the void space maintained between first sheet of material 112 and a second sheet of material 114. In one aspect of this embodiment, dimples 116 may contact first sheet of material 112 and may be spot welded to first sheet of material 112. The spot welding may be resistance welding. The number and arrangement of dimples 116 included in second sheet of material 114 is not limited. Dimples 116 may be arranged in a pattern or may be located randomly about second sheet of material 114.

First sheet of material 112 and second sheet of material 114 may be any suitable material for use in a solar collection panel 110. In one aspect of this embodiment, first sheet of material 112 and second sheet of material 114 comprise steel or stainless steel. By using steel or stainless steel for first sheet of material 112 and second sheet of material 114, solar collection panel 110 may have increased strength allowing it to be used in the non-rectilinear shapes described above. Furthermore, the strength of steel and stainless steel is such that a solar collection panel comprising steel or stainless steel first sheet of material 112 and second sheet of material 114 may be used as the wall of a structure. In one example embodiment, stainless steel sheets 112 and 114 are one inch thick, and dimples 116 are 0.1 inches in depth, creating a total lateral separation of 0.2 inches between the adjacent stainless steel sheets 112 and 114.

A specialized spot welder, such as for example described below, may be used for spot welding dimples in the first 112 and second 114 sheets of material.

Solar collection panel 110 may be housed in a box in order to protect solar collection panel 110. The box may have one open side and solar collection panel 110 may be positioned in the box such that second sheet of material 114 faces out of the box and towards the sky. The box may be made of any suitable material, such as steel, aluminum or wood. In one aspect, the box further comprises insulation positioned with the box and which solar collection panel 112 may be positioned on. The box may also comprise a glass cover which is placed over the open end of the box to encapsulate solar collection panel 112 inside of the box. The glass cover may be tempered glass.

With or without the box, solar collection panel 112 may be positioned at an angle and facing a predetermined direction so as to maximize sun exposure. In one aspect, solar collection panel 112 may move throughout the day (both direction and angle) to maximize sun exposure. Movement of solar collection panel 112 may be automated. The location of solar collection panel 112 may be on the ground or attached to a structure. Solar collection panel 112 may also be positioned in any suitable location relative to fluid-containment vessel 120 (i.e., above, to the side, below, etc.).

Solar collection panel 110 may include a fluid outlet at a second end and a fluid inlet at a first end which allows fluid in the void space between first sheet of material 112 and second sheet of material 114 to flow in and out of solar collection panel 110. When solar collection panel is positioned at an incline, the fluid inlet port may be located at the lower end of solar collection panel 110 and the fluid outlet may be positioned at the higher end of solar collection panel 110.

Fluid inlets and fluid outlets (collectively “fittings”) may take the form of fittings attached to solar collection panel 110. FIG. 4C illustrates various configurations for the fittings. Fitting 118 may be secured to first sheet of material 112 as shown in FIG. 4C, but may also be secured to second sheet of material 114 in an alternate configuration. Fitting 118 is secured to first sheet of material 112 at a location where first sheet of material 112 has an opening to provide for fluid communication between solar collection panel 110 and fitting 118. FIG. 4C also illustrates how fitting 118 may be secured to first sheet of material 112 at a variety of different angles. In one aspect, fitting 118 is secured to first sheet of material 112 at a right angle. In another aspect, fitting 118A is secured to first sheet of material 112 at a 45 degree angle; and this angled structure may be used to, among other thins, provide pipe interconnections and heat transfer fluid flow between panels. The 45 degree angle configuration may be used at the top of solar collection panel 110, such as to eliminate the possibility of an air trap in the pipe.

Fittings 118 may have any suitable shape or size. As shown in FIG. 4C, fittings 118 have a “top hat” shape, with a cylindrical body and a circular flange at one end. Fittings 118 may also be made from any suitable material. In one aspect, fittings 118 comprise copper. The manner of securing fittings 118 to solar collection panel 110 is not limited. In one aspect, fittings 118 are silver brazed to first sheet of material 112.

Fluid-containment vessel 120 shown in FIG. 3 may be any suitable vessel for storing fluid. Fluid-containment vessel 120 may be a closed fluid-containment vessel that does not provide exposure of its contents to the outside atmosphere. The shape and size of fluid-containment vessel 120 are not limited and may be dictated by the needs of the user. For example, larger residential buildings may require a larger fluid-containment vessel since larger quantities of water will be required. Similarly, the material of fluid-containment vessel 120 is not limited. In one aspect, the material of fluid-containment vessel 120 may be a material that is corrosion resistant to water and a heat exchange fluid so that fluid-containment vessel 120 does not corrode upon contact with water on the interior of fluid-containment vessel 120 and heat exchange fluid on the exterior of fluid-containment vessel 120.

Fluid containment vessel 120 may have an inner surface and an outer surface opposite the interior surface. In one aspect, fluid-containment vessel 120 is a single-walled fluid-containment vessel. As shown in FIG. 3, fluid-containment vessel 120 may have a cylindrical shape.

Fluid-containment vessel 120 may include one or more heat exchanger walls 130 secured to the outer surface of fluid-containment vessel 120. Heat exchanger walls 130 may be secured to any side of fluid-containment vessel 120 and may be secured by any suitable means to fluid-containment vessel 120 such that a liquid tight seal is created between fluid-containment vessel 120 and heat exchanger walls 130.

Heat exchanger walls 130 may have any suitable shape and dimension. In one aspect illustrated in FIG. 3, heat exchanger walls 130 may be rectangular. However, heat exchanger walls 130 may also be circular, triangular or a polygon having any number of sides. Heat exchanger walls 130 may also comprise any suitable material. In one aspect, heat exchanger walls 130 may comprise steel or stainless steel. When heat exchanger walls 130 comprise steel or stainless steel, heat exchanger walls 130 may have the strength necessary to use non-rectilinear shapes.

Heat exchanger walls 130 may comprise a first end, a second end opposite a first end, peripheral edges, and a central portion surrounded by peripheral edges. The central portion of heat exchanger walls 130 may protrude above the peripheral edges.

Heat exchanger walls 130 may be secured to fluid-containment vessel 120 by securing peripheral edges of heat exchanger walls 130 to the outer surface of fluid-containment vessel 120. Any suitable method of securing the peripheral edges of heat exchanger walls 130 to fluid-containment vessel may be used. In one example, peripheral edges of heat exchanger walls 130 may be secured to fluid-containment vessel 120 by strapping heat exchanger walls 130 to fluid-containment vessel 120, or by seam welding.

When securing heat exchanger walls 130 to fluid-containment vessel 120, heat exchanger walls 130 may be oriented such that the central portion of 130 heat exchanger walls protrude away from the outer wall of fluid-containment vessel, thereby creating a heat exchange fluid cavity between the outer surface of fluid containment vessel 120 and heat exchanger walls 130. The distance the central portion of heat exchanger walls 130 protrudes away from fluid-containment vessel 120 is not limited and may be any distance allowing fluid to flow through the cavity.

Heat exchanger wall 130 may include one or more dimples 132 in the central portion of heat exchanger wall 130. Dimples 132 may extend back towards the peripheral edges of heat exchanger wall 130. In other words, when heat exchanger wall 130 is secured to fluid-containment vessel 120 as described above, dimples 132 extend towards the outer wall of fluid-containment vessel 120. Dimples 132 may extend towards fluid-containment vessel 120 until dimples 132 contact fluid-containment vessel 120. Dimples 132 may be secured to fluid-containment vessel 120 by any suitable means, including welding, and more specifically, resistance welding. The central portion of heat exchanger wall 130 may include any number of dimples 132, and dimples 132 may be arranged in a pattern or randomly about the central portion of heat exchanger wall 130.

Heat exchanger wall 130 may include a fluid port at the first end and second end of heat exchanger wall 130. Fluid ports allow fluid to flow in and out of the cavity formed between the outer wall of fluid-containment vessel 120 and heat exchanger wall 130. In one aspect, fluid ports may be similar to fittings 118 described in greater detail above.

According to the above description of heat exchanger walls 130, a cavity is formed between heat exchanger wall 130 and the outer surface of fluid-containment vessel 120. In an alternate aspect of this embodiment, heat exchanger 130 may be similar to solar collection panel 110 illustrated in FIG. 4A-2 in that heat exchanger wall 130 will comprise a first flat sheet of material and a second sheet of material having crimps and dimples formed therein. In this configuration, the cavity through which fluid flows is formed between the two sheets of material of heat exchanger 130 rather than between heat exchanger wall 130 and fluid-containment vessel 120.

Contrary to the straight configuration shown in FIG. 4A-2, heat exchanger wall 130 having two sheets of material may be curved or otherwise shaped to conform to the shape of fluid-containment vessel 120. When fluid-containment vessel 120 is cylindrical, heat exchanger wall 130 may be curved such that the first flat sheet of material may mate flushly with the outer surface of fluid-containment vessel 120 (i.e., the dimples in the second sheet of material will extend towards fluid-containment vessel 120 when heat exchanger wall 130 is mounted on fluid containment vessel 120). In this configuration, fluid of the solar heating system will not directly contact fluid-containment vessel 120. Furthermore, heat transferred from the fluid flowing between the two sheets of material of heat exchanger walls 130 to the fluid within fluid-containment vessel 120 will have to pass through the first flat sheet of material of heat exchanger wall 130 and the wall of fluid-containment vessel 120.

The above-described configuration is useful as a retrofit to existing fluid-containment vessels. Heat exchanger walls 130 having two sheets of material may be secured to any existing fluid containment vessel using any suitable means of attachment, including strapping heat exchanger walls 130 to fluid containment vessel 120.

Solar heating system 100 may further comprise first set of piping 140 and second set of piping 150. First set of piping 140 and second set of piping 150 may be made from any suitable material for transporting fluid throughout solar heating system 100. In one aspect, first set of piping 140 and second set of piping 150 is a material resistant to corrosion by fluid that may be flowing through solar heating system 100, such as water or heat exchange fluid. Similarly, first set of piping 140 and second set of piping 150 may have any suitable shape or dimensions, and the length of first set of piping 140 and second set of piping 150 may be determined by how far solar collection panel 110 and fluid-containment vessel 120 are spaced apart from each other.

First set of piping 140 may provide fluid communication between the second end of solar collection panel 110 and the first-end of heat exchanger wall 130. More specifically, first set of piping is connected to the fluid outlet located at the second end of solar collection panel 110 and the fluid port located at the first end of heat exchanger wall 130. In this manner, liquid leaving solar collection panel 110 travels to heat exchanger wall 130 via first set of piping 140. Second set of piping 150 may provide fluid communication between the second end of heat exchanger wall 130 and the first end of solar collection panel 110. More specifically, second set of piping 150 is connected to the fluid port located at the second end of heat exchanger wall 130 and the fluid inlet located at the first end of solar collection panel 110. In this manner, liquid leaving heat exchanger walls 120 travels to solar collection panel 110 via second set of piping 150.

Fluid running through solar heating system 100, including solar collection panel 110, first set of piping 140, second set of piping 150 and the heat exchange fluid cavity between fluid-containment vessel 120 and heat exchanger wall 130, may be any suitable heat exchange fluid suitable for absorbing solar heat in solar collection panel 110 and transferring heat to water stored in fluid-containment vessel 120. In one aspect, the fluid is propylene glycol.

A second embodiment of the instant disclosure relates to a storage tank having an integrated heat exchanger. The storage tank may be used together with a solar collection panel as part of a solar heating system such as the one described above.

The storage tank may be similar to the fluid-containment vessel described above in the first embodiment. The storage tank may comprise a single-walled fluid containment vessel with one or more heat exchanger walls adhered to the exterior of the single-walled fluid containment vessel. The one or more heat exchanger walls protrude away from the single-walled fluid containment vessel so as to form cavities between the fluid containment vessel and the heat exchanger walls. Heat exchange fluid having flowed through a solar collection panel is then passed into the cavities and the heat from the heat exchange fluid passes through the single-walled fluid containment vessel to heat the fluid flowing inside the single-walled fluid containment vessel. The storage tank of the second embodiment represents an improvement over coiled heat exchangers located inside storage tanks in that the storage tank of the second embodiment provides much more surface area for heat exchange, and is therefore a more efficient way of heating fluid inside the storage tank.

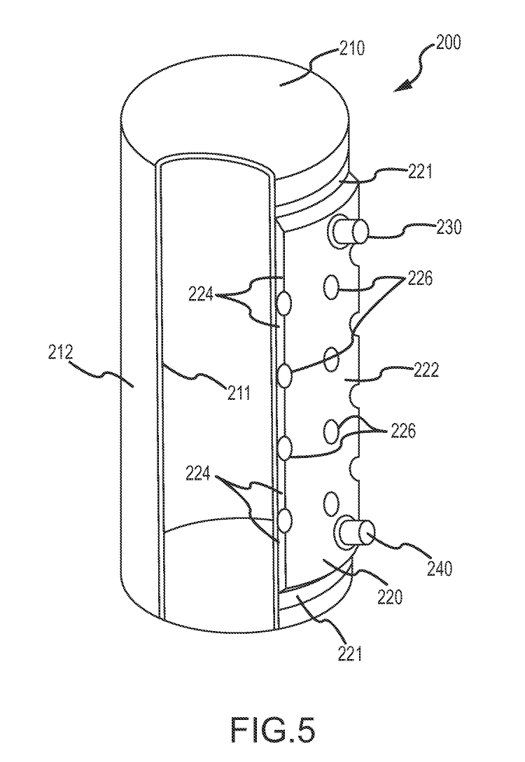

FIG. 5 illustrates a cross-section of a storage tank 200 according to the second embodiment. As noted above, storage tank 200 generally comprises a single-walled fluid containment vessel 210 and one or more heat exchanger walls 220. Heat exchanger walls 220 are positioned on an outer surface 212 of single-walled fluid containment vessel 210 and create cavities 224 between heat exchanger wall 220 and single-walled fluid containment vessel 210.

Single-walled fluid containment vessel 210 may comprise an inner surface 211 and an outer surface 212 opposite inner surface 211. The distance between inner surface 211 and outer surface 212 (i.e., the thickness of single-walled fluid containment vessel 210) is not limited, but is preferably not so great as to severely impede heat transfer from outer surface 212 to inner surface 211. The overall shape of single-walled fluid containment vessel 210 is also not limited. As shown in FIG. 5, single-walled fluid containment vessel 210 may have a cylindrical shape. In alternate configurations, fluid containment vessel 210 may have a cube-like shape or the like. The overall size and volume of fluid containment vessel 210 is not limited and will likely vary depending on the needs of the user.

Single-walled fluid containment vessel 210 may be a closed vessel that does not provide exposure of its contents to the outside atmosphere. The material of single-walled fluid containment vessel 210, may be any suitable material capable of retaining fluid. In one aspect, the material of fluid-containment vessel 210 may be a material that is corrosion resistant to water and a heat exchange fluid so that fluid-containment vessel 210 does not corrode upon contact with water on the interior of fluid-containment vessel 210 and heat exchange fluid on the exterior of fluid-containment vessel 210

One or more heat exchanger walls 220 may each comprise peripheral edges 221 and a central portion 222 surrounded by peripheral edges 221. Central portion 222 may protrude away from peripheral edges 221. Heat exchanger walls 220 may be straight, angled, or curved, depending on the shape of single-walled fluid containment vessel 210 to which heat exchanger walls 220 are adhered and the location on single-walled fluid containment vessel 210 where heat exchanger walls 220 are adhered. For example, as shown in FIG. 5, heat exchanger walls 220 are curved to conform to the cylindrical shape of single-walled fluid containment vessel 210. The material of heat exchanger walls 220 may be any suitable material for retaining fluid. In one aspect, the material of heat exchanger wall 220 may be steel or stainless steel. When heat exchanger walls 220 comprise steel or stainless steel, the strength of heat exchanger wall 220 may be such that different shapes of heat exchanger walls 220 as described below may be used.

The various dimensions of each heat exchanger wall 220 are not limited and may generally have any dimensions that allow heat exchanger walls 220 to maintain fluid between heat exchanger walls 220 and single-walled fluid containment vessel 210. While FIG. 5 illustrates heat exchanger walls 220 having rectangular shapes, heat exchanger walls may also have any other type of shape, such as triangular, circular or a polygon having any number of sides. Multiple heat exchanger walls 220 adhered to single-walled fluid containment vessel 210 may be identical or different from one another. For example, some heat exchanger walls 220 may have rectangular shapes while other heat exchanger walls 220 may have triangular shapes.

Heat exchanger walls 220 may be adhered to outer surface 212 of single-walled fluid containment vessel 210. More specifically, peripheral edges 221 of heat exchanger walls 220 may be adhered to outer surface 212 of single-walled fluid containment vessel 210. When adhered to single-walled fluid containment vessel 210, the orientation of heat exchanger walls 220 may be such that central portion 222 protrudes away from outer surface 212 of single-walled fluid containment vessel 210. In this manner, heat exchanger walls 220 form cavities 224 between single-walled fluid containment vessel 210 and heat exchanger walls 220. The distance central portion 222 protrudes away from fluid-containment vessel 210 is not limited and may be any distance allowing fluid to flow through cavity 224.

Heat exchanger walls 220 may be secured to fluid-containment vessel 210 at any location on outer surface 212 of fluid-containment vessel 210. Furthermore, heat exchanger walls 220 may be secured by any suitable means to fluid-containment vessel 210 so long as a liquid tight seal is created between fluid-containment vessel 210 and peripheral edges 221 of heat exchanger walls 220. In one aspect, peripheral edges 221 of heat exchanger walls 220 are secured to single-walled fluid containment vessel 210 via welding, and more specifically, via resistance welding. In another aspect, heat exchanger walls 220 may be secured to fluid-containment vessel 210 by strapping heat exchanger walls 220 to fluid-containment vessel 210.

Central portion 222 of heat exchanger wall 220 may include one or more dimples 226. Dimples 226 may extend back towards peripheral edges 221 of heat exchanger wall 220. In other words, when heat exchanger wall 220 is secured to fluid-containment vessel 210 as described above, dimples 226 extend towards outer surface 212 of fluid-containment vessel 210. Dimples 226 may extend towards fluid-containment vessel 210 until dimples 226 contact fluid-containment vessel 210. The portions of dimples 226 contacting fluid containment vessel 210 may be secured to fluid-containment vessel 210 by any suitable means, including welding, and more specifically, resistance welding. Central portion 222 of heat exchanger wall 220 may include any number of dimples 226, and dimples 226 may be arranged in a pattern or randomly about central portion 222 of heat exchanger wall 220.

As described in greater detail in the previous embodiment, heat exchanger walls 220 may alternatively comprise two sheets of material similar to the configuration illustrated in FIG. 4A-2. When mounting heat exchanger wall 220 according this design to fluid-containment vessel 210, the first flat sheet of material may be flush against fluid-containment vessel 210 and fluid may flow between the two sheets of material rather than between heat exchanger wall 220 and fluid-containment vessel 210.

Heat exchanger wall 220 may include a fluid inlet port 230 and a fluid outlet port 240. Fluid inlet port 230 and fluid outlet port 240 allow fluid to flow in and out of cavity 224. In operation, fluid heated by a solar collection panel flows into cavity 224 via fluid inlet port 230, transfers heat through the wall of fluid containment vessel 210 to fluid inside fluid containment vessel 210, exits cavity 224 via fluid outlet port 240, and returns to solar collection panel to absorb more heat and repeat the cycle. Fluid inlet port 230 and fluid outlet port 240 may be similar to fitting 118 described in greater detail above. Fluid flow may also be in reverse to the direction described above.

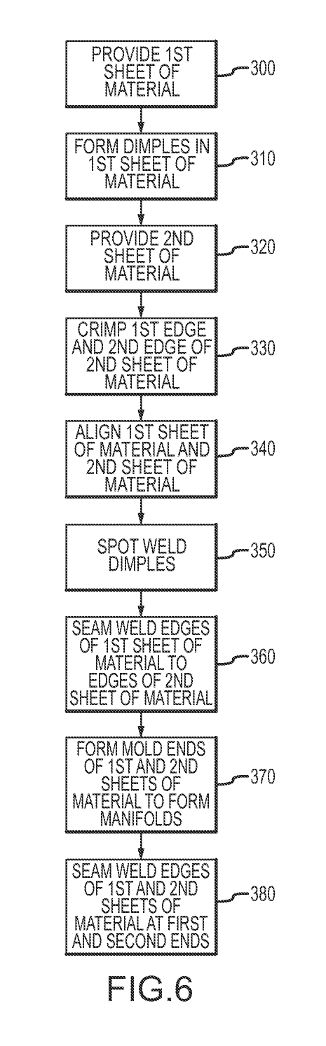

A third embodiment of the instant disclosure relates to a method of constructing a solar collection panel. The solar collection panel may be an envelope-style solar collection panel such as the one described above in the first embodiment. FIG. 6 illustrates a flow diagram of the method of the third embodiment.

In a first step 300 of the method, a first sheet of material may be provided. The first sheet of material may comprise a first side edge, a second side edge opposite the first side edge, a first end, a second end opposite the first end, and a central portion surrounded by the first side edge, second side edge, first end and second end. The shape and dimensions of the first sheet of material are not limited and may be any suitable size for manufacturing the solar collection panel. The shape of the first sheet of material may be circular, triangular, rectangular or a polygon having any number of sides. The shapes may also be regular or irregular. The material of the first sheet of material is also not limited. In one aspect of this embodiment, the first sheet of material may comprise steel, stainless steel, aluminum, or copper.

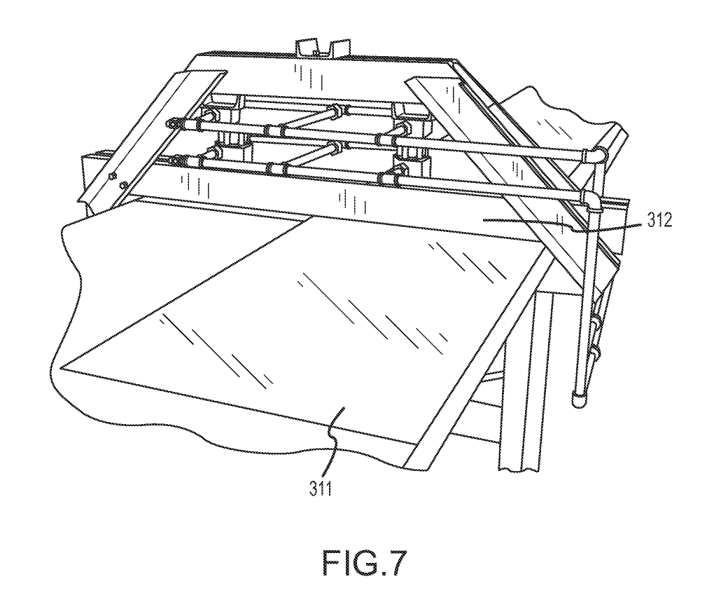

In a subsequent step 310, one or more dimples may be formed in the first sheet of material. The number, size, depth, and arrangement of dimples formed in the first sheet of material is not limited. In one aspect of this embodiment, the dimples are all uniform and all extend in the same direction. Dimples may be formed by any suitable method, including the use of a hydraulic dimpler. As shown in FIG. 7, the first sheet of material 311 may be fed under two rows of dimplers 312, wherein the dimplers 312 in the first row are offset from the dimplers 312 in the second row. Hydraulic cylinders may force the rows of dimplers 312 down upon the first sheet of material 311, thereby creating two rows of dimples in the first sheet of material 311 that are offset from one another. Advancement of the first sheet of material through the dimpler 312 may be by hand or may be automated.

In a next step 320, a second sheet of material is provided. The second sheet of material may have a first edge, a second edge opposite the fist edge, a first end, and a second end opposite the first end. The shape and dimensions of the second sheet of material are not limited and may be any suitable size for manufacturing the solar collection panel. The shape of the second sheet of material may be circular, triangular, rectangular or a polygon having any number of sides. The shapes may also be regular or irregular. The material of the second sheet of material is also not limited. In one aspect of this embodiment, the first sheet of material may comprise steel, stainless steel, aluminum, or copper. When the material is steel or stainless steel, the non-rectilinear shapes described above may be used without sacrificing strength. In one aspect of the method, the shape and dimensions of the second sheet of material are approximately the same as the shape and dimensions of the first sheet of material.

Step 320 of providing a second sheet of material need not be performed after steps 300 and 310, and may be performed before steps 300 and 310 or between steps 300 and 310.

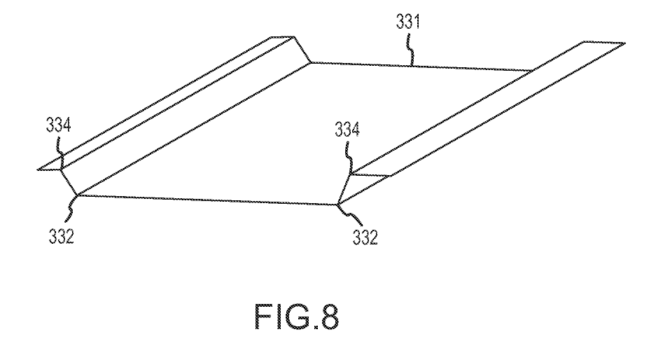

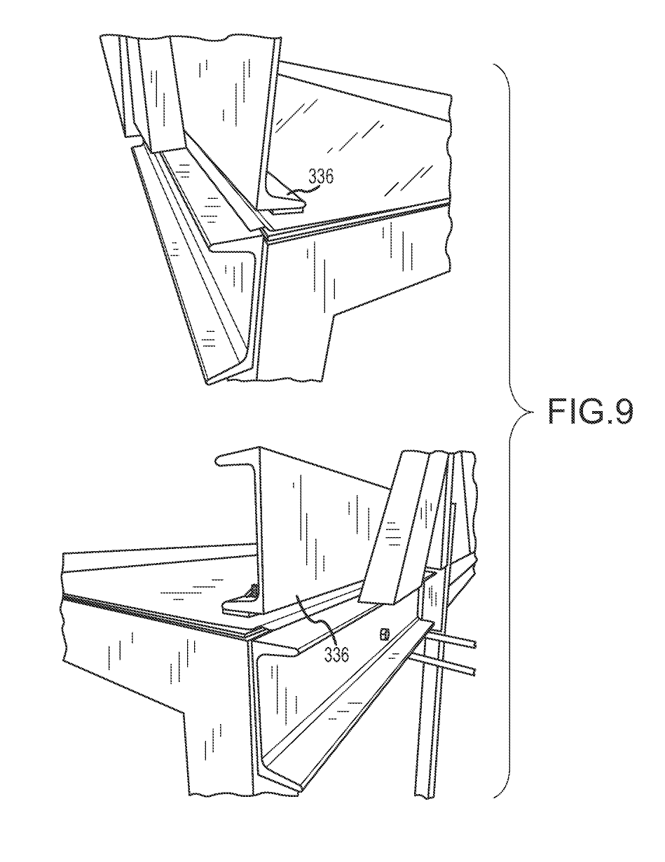

In a next step 330, the first edge and second edge of the second sheet of material may be crimped. Crimping may comprise bending the first and second edges of the second sheet of material such that the first and second edges are in a different plane from the remainder of the second sheet of material but generally parallel to the remainder of the second sheet of material. Crimping may generally form two bends in the first and second edges of the second sheet of material to thereby create a valley between the angled first and second edges. As shown in FIG. 8, the first bend 332 may angle the first and second edges upwards from the second sheet of material 331. The angle of the first bend 332 is not limited and may be any suitable angle for creating the valley between the first and second edges. As also shown in FIG. 8, the second bend 334 levels out the first and second edges so that the first and second edges are generally parallel to the valley portion of the second sheet of material 331. The crimps in the first and second edges of the second sheet of material may generally run the length of the first and second edge of the second sheet of material. The crimp may be formed by any suitable method for bending the second sheet of material in the above-described manner. As shown in FIG. 9, the crimp is formed in each edge by placing the first and second edges in a mold 336 that when pressed together forms a crimp in the first and second edge. The crimp formed in the first edge may be similar in shape and dimension to the crimp formed in the second edge.

In an alternate aspect of the first embodiment, crimps may be formed in the first side edge and second side edge of the first sheet of material rather than in the second sheet of material. In this aspect, both the dimples and the crimps are formed in the same sheet Consequently, the second sheet of material is left flat. This configuration is similar to that illustrated in FIG. 4A-2.

In a next step 340, the first sheet of material and the second sheet of material may be aligned. Aligning the first and second sheet of material may generally comprise aligning the first end of the first sheet of material with the first end of the second sheet of material, aligning the second end of the first sheet of material with the second end of the second sheet of material, aligning the first side edge of the first sheet of material with the first crimped edge of the second sheet of material, and aligning the second side edge of the first sheet of material with the second crimped edge of the second sheet of material. The first sheet of material and the second sheet of material may also be aligned such that the dimples in the first sheet of material extend into the valley between first and second crimped edges of the second sheet of material. In one aspect, the dimples may contact the valley portion of the second sheet of material when the first sheet of material is aligned with the second sheet of material. The step of aligning the first sheet of material and the second sheet of material may be completed by hand or may be an automated step performed by machinery.

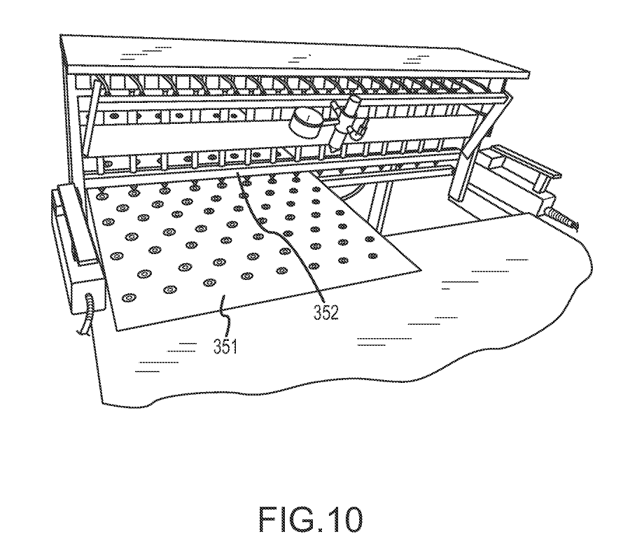

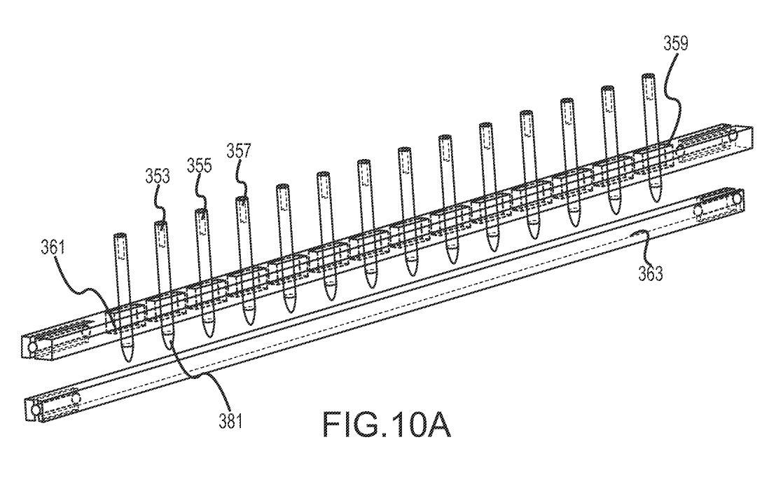

In a next step 350, the dimples in the first sheet of material may be spot welded to the valley of the second sheet of material (or to the flat second sheet of material where crimps are formed in the first sheet of material). The spot welding may be performed by hand or by automated machinery. As shown in FIGS. 10 and 10A, a sequential spot welder 352 may be used to spot weld all the dimples in a single row at once. The aligned first and second sheets of material 351 may be passed through the sequential spot welder 352 in order to spot weld sequential rows of dimples. Weld pins, e.g., 353, 355, 357, may be slidably mounted within associated pin passages, e.g., 361, in a first or upper copper current conductor bar assembly 359; and second or lower copper current conductor bar 363 is mounted below the first current conductor bar assembly 359 so that the first and second sheets of material 351 may therefore pass between the first current conductor bar assembly 359 and second current conduct bar 363. Each weld pin, e.g., 353, 355, 357, in the conductor bar assembly 359 can be driven by an associated pneumatic cylinders (such as a model 6W097M made by Dayton) or solenoid valve (not shown) mounted above the weld pin and conductor bar assembly, and the actuating time for each such cylinder and pin can be controlled by a weld timer (not shown). The lateral spacing maintained between the weld pins, e.g., 353, 355, 357, mates with the lateral spacing between troughs in laterally adjacent dimples in the first and second sheets of material 351.

In one exemplary embodiments, the weld pins, e.g., 353, are made of silver plated copper and coated with ultra fine graphite lubrication. Exemplary vertical spacing from the lowermost edge of upper conductor bars 361 and the lowermost tip, e.g, 381, of an adjacent pin 353 is one inch; this type of spacing seeks to place the assembly bars 365, 367 close to the weld points of associated weld pins, e.g., 353.

In one embodiment, the first conductor bar 359 and second conductor bar 363 are each connected at each end to one of two 120 volt AC transformers (not shown) that provide 1.5 volts between the first conductor bar assembly 359 (and its associated weld pins, e.g., 353, 355; 357) and second conductor bar 363. This arrangement can help equalize voltage and current carrying capability through the full length of first conductor bar assembly 359 and second conductor bar 363.

Exemplary AC transformers are model MSW-41 manufactured by Miller. An exemplary welding timer is model MSW-41 manufactured by Miller. The spot welder 352 is 16″ by 58″ and is 64″ high and uses 110V, single phase power on a 20 amp breaker. Exemplary pins are replaceable such as by threading on threaded heads.

The spot welder 352 is thus compact but locates the welding wheels 362, 704 at a comfortable height for most adults to work with the welder 700. Wheels (not shown) can be mounted to the bottom of the seam welder 700.

The timing and voltage used for each spot weld may vary depending on factors such as the thickness and material of the first and second sheets of material 351. In one aspect of this embodiment, each spot weld may be conducted within a range of from 0.01 seconds to 9.9 seconds. The weld pins may be designed so as not to fire when material is not located under the weld pin. In one aspect of this embodiment, the spot welding may be resistance spot welding.

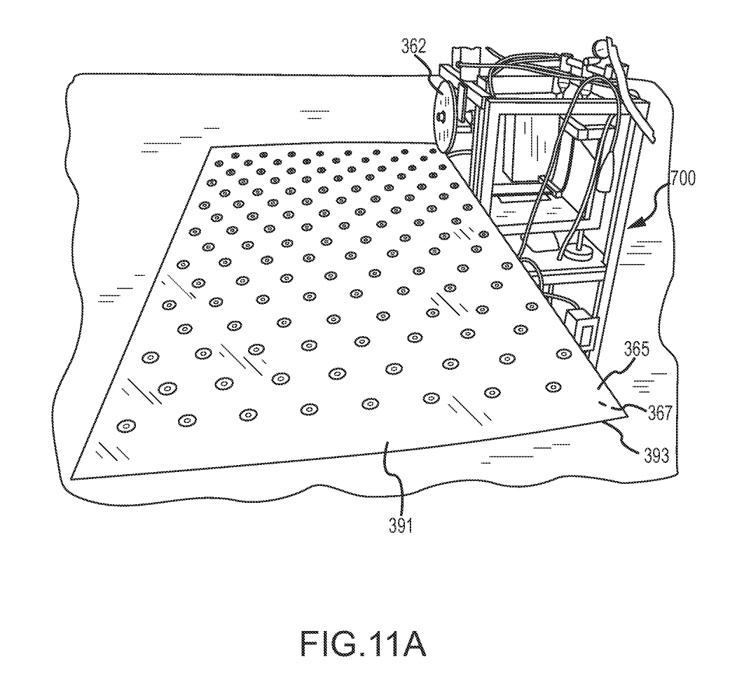

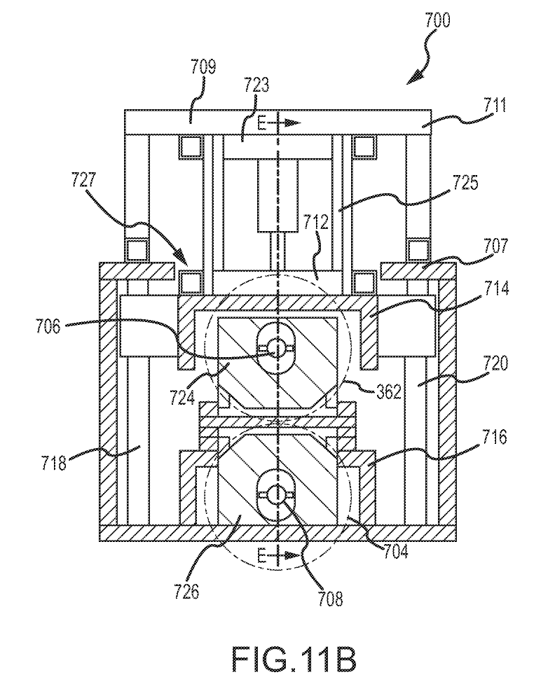

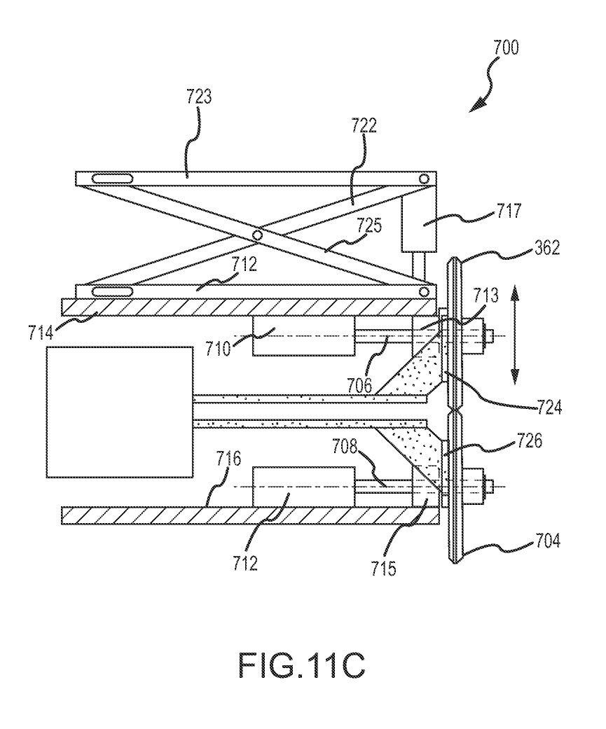

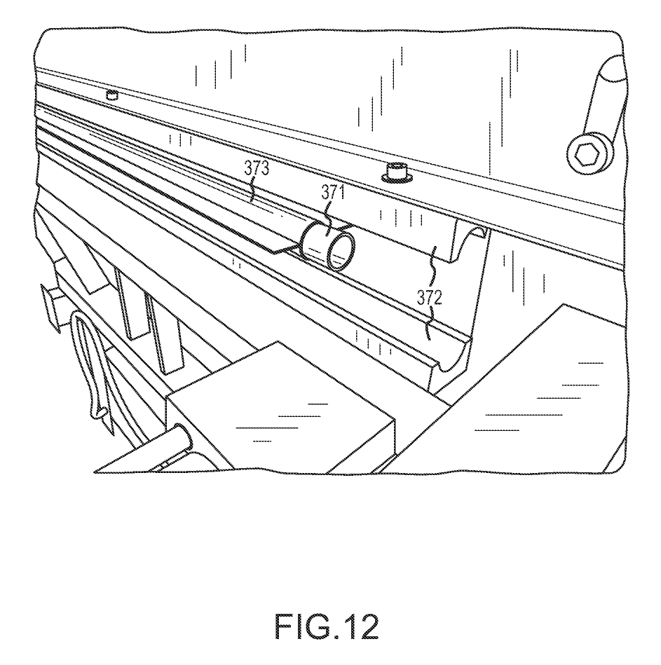

In a next step 360, the first side edge of the first sheet of material may be seam welded to the first crimped edge of the second sheet of material and the second side edge of the first sheet of material may be seam welded to the second crimped edge of the second sheet of material (or, in the alternative configuration, crimped first side edge of the first sheet of material may be seam welded to the first flat edge of the second sheet of material and the crimped second side edge of the first sheet of material may be seam welded to the second flat edge of the second sheet of material). These seam welding steps may be performed simultaneously or sequentially. These seam welding steps may also be performed by hand or by an automated machine. As shown in FIGS. 11A-C, the seam welding may be performed by passing the edges between two welding wheels, 362, 704. The pressure exerted by these two wheels 362 may be controlled by pneumatic pressure and the wheels 362, 704 may be moved along the length of the first and second sheets of material by an electric gear motor or motors. The speed of the wheels and voltage supplied to the wheels may be adjusted to create a optimum seam weld. The seam weld may be a resistance seam weld. The seam weld may be created along the entire length of the first upper 391 and second lower 393 sheets of material or at shorter sections along the length of the first 391 and second 393 sheets of material. In one aspect of the embodiment, the seam weld is spaced (not shown) inwardly from the first and second ends or edge sections, e.g., 365, 367, each side of the first and second sheets of material so that the edge sections, e.g., 365, 367 may be molded in one or more subsequent steps described in greater detail below (such as to form an expanded fluid flow channel or manifold in the edge sections, e.g., 365, 367).

In a next step 370, the first end of the first sheet of material and the first end of the second sheet of material are faun molded to form a first manifold and the second end of the first sheet of material and the second end of the second sheet of material are form molded to form a second manifold. The first and second manifolds may be molded simultaneously or sequentially. The molded manifolds may generally comprise hollow tubes extending the length of the first and second ends of the first and second sheets of material and serve to distribute fluid flowing into the solar collection panel at one end and to collect fluid flowing out of the solar collection panel at an opposite end. The manifolds may have any suitable shape, and in one aspect, the manifolds have a cylindrical shape. The manifolds may be formed by any suitable shaping method, including hand molding or use of automated machinery. In one aspect illustrated in FIG. 12, the first and second ends of the first and second sheets of material may be molded into manifolds by inserting a rod 371 between the first and second sheets of material at the first or second end of the first and second sheets of material. Molds 372 generally conforming to the shape of the rod 371 may then be closed around the rod 371, which thereby shapes the first and second ends of the first and second sheets of material to the shape of the rod 371 deposited therebetween. The rod 371 may then be removed, leaving behind manifolds 373 at the first and second ends of the first and second sheets of material. After the manifold has been formed, a copper stub may be placed in each end of the manifold. Copper stubs, are used to later connect the solar collection panel to the overall solar heating system or to each other in a parallel bank of collectors. The copper stubs may extend out of the ends of the manifold, such that a portion of the copper stubs are inside the manifold and a portion of the copper stubs are outside of the manifold. The copper stubs may have a cross-sectional size approximately equal to the cross-sectional size of the manifolds.

In an alternate step to step 370, fittings may be used in place of manifolds to provide a fluid inlet and outlet for the solar collection panel. Fittings may be similar to fitting 118 described in detail above. Fittings may be secured to either first sheet of material or second sheet of material. Any suitable manner of securing the fittings to the first or second sheet of material may be used, including silver brazing as discussed above. When fittings are used in place of manifolds, the method disclosed herein further requires a step of forming one or more holes in first or second sheet of material where fittings will be attached to provide fluid communication between the solar collection panel and the fitting. The holes may be formed by any suitable means and at any suitable point during the manufacturing method. The holes may have a size approximately equal to the size cross-sectional size of the fittings.

In another step 380, the first end of the first sheet of material may be seam welded to the first end of the second sheet of material and the second end of the first sheet of material may be seam welded to the second end of the second sheet of material. The seam welding of the first ends and second ends may be performed simultaneously or sequentially. The seam welding may be similar or identical to the seam welding as described above in step 360.

Where the manufacturing method comprises inserting copper stubs into the manifolds as described above, the copper stubs may be silver brazed to the manifolds after the seam welding step 380 is performed to seam weld together the ends of the first and second sheets of material.

At any point during the above described method, the color of the first sheet of material and second sheet of material may be changed. Changing the color of the first sheet of material and the second sheet of material may be achieved by any suitable means, such as painting or dyeing. Any type of paint may be used to change the color of the first and second sheets of material, including commercially available paints, such as Glidden™, Behr™ or Benjamin Moore™. The color may be changed to any color, including red, orange, yellow, green, blue, indigo and violet or any shade thereof. In one aspect, the color is a dark shade of one of the previously mentioned colors.

A fourth embodiment of the instant disclosure is directed to a solar collection panel manufactured by the method described in detail in the third embodiment. The solar collection panel may include a first sheet of material and a second sheet of material comprising steel or stainless steel. The strength of these materials in molded configurations may allow for the creation of integral manifolds in the solar collection panel as described in greater detail above. The integrally formed manifolds ensure liquid flowing through the solar collection panel is freely and evenly distributed through the collection panel. Additionally, the envelope configuration, including dimples in the first sheet of material spot welded to the second sheet of material, provides for an improved solar collection panel that includes increased surface area for heat transfer between heat exchange fluid flowing through the solar collection panel and the first sheet of material as compared to prior art designs.

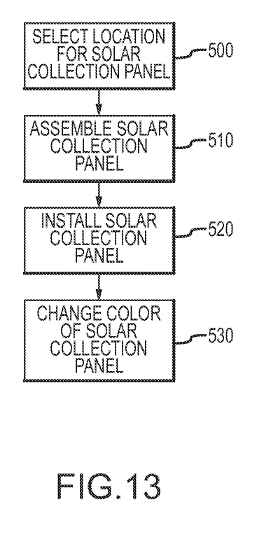

A fifth embodiment of the instant disclosure is related to a method of installing a solar collection panel on a structure. The solar collection panel may be any suitable solar collection panel for installing on a structure and which may be connected to the structure to provide solar heating. For example, the solar collection panel may be the solar collection panel described above in the fourth embodiment and manufactured by the method described above in the third embodiment. In one aspect of the fifth embodiment, the solar collection panel is one which has a non-rectilinear shape and is installed on the structure so as to blend into the shape of the structure. FIG. 13 illustrates a flow diagram of the method of the fifth embodiment.

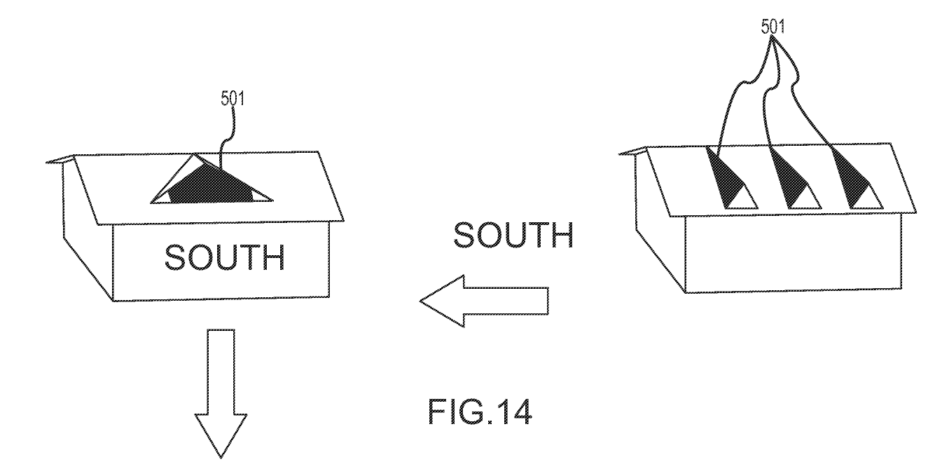

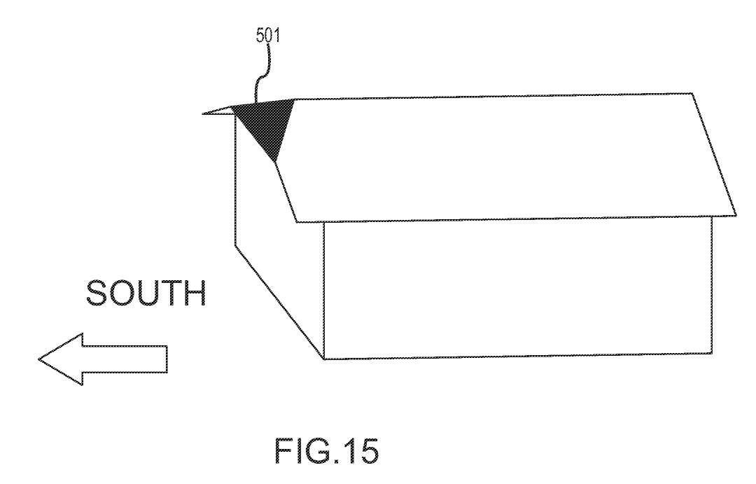

In a first step 500, a location on a structure is selected for installing the solar collection panel. The structure may be any type of structure which may benefit from solar heating. For example, the structure may be a single family residence, a multi-unit residence, a commercial business, a water tower, and the like. The location on the structure is also not limited. In one aspect, the location is a location on the structure that is exposed to sunlight throughout the day. The location on the structure may also be selected so as to blend in with the structure. FIGS. 14 and 15 illustrate examples of how a location on a structure may be selected so as to allow the solar collection panel 501 to blend into the structure. In FIG. 14, the solar collection panels 501 are positioned on architectural finishes included on the roof of the structure. In FIG. 15, the solar collection panel 501 is positioned at the end of the apex of the roof. In this manner, the solar collection panels 501 do not protrude above or away from the structure and, in some cases, may even result in an observer not realizing that a solar collection panel 501 is included on the structure.

In a second step 510, the solar collection panel may be assembled. As noted above, any type of solar collection panel may be used in this method, and therefore any method of assembling a solar collection panel may be used in step 510. In one aspect of this embodiment, the solar collection panel is similar to those described above in the second and third embodiments. In some embodiments, the solar collection panel can be arranged as a patio roof or other covering or protective structure, supported by suitable framing as desired. The solar collection panels may also be installed with spacing between associate panels to allow light or other elements to pass through the spacing, thereby creating a filtering effect without providing a complete cover.

In one aspect, step 510 comprises assembling a solar collection panel having a first sheet of material and a second sheet of material. The first sheet of material may have peripheral edges and a central portion surrounded by the peripheral edges. The central portion may protrude away from the peripheral edges to thereby create a cavity within the first sheet of material. The second sheet of material may have peripheral edges and a central portion surrounded by the peripheral edges. The central portion of the second sheet of material may have one or more dimples formed therein. The number and arrangement of dimples is not limited. The dimples may all extend in one direction away from the second sheet of material. The first and second sheets of material may have approximately the same shape and dimensions so that they may be aligned with one another. The peripheral edges of the first sheet of material may be aligned with the peripheral edges of the second sheet of material. In one aspect, the first sheet is aligned with the second sheet such that the dimples in the second sheet of material extend into the cavity in the first sheet of material. As described in greater detail above, dimples may be spot welded to the first sheet of material. The peripheral edges of the first sheet and second sheet may also be welded together.

In assembling the solar collection panel, the solar collection panel may also be shaped so as to conform to the location selected in step 500 for installation. This may be done by shaping the first sheet of material and second sheet of material prior to assembling the two pieces together or after the two pieces have been assembled together. The shape may be circular, triangular, rectangular or a polygon having any number of sides. The shape may regular or irregular. Using steel or stainless steel for the first and second sheet of material helps to ensure that the solar collection panel still retains strength. In one example, when constructing a solar collection panel of the type to be used as shown in FIG. 15, the first and second sheets of the solar collection panel 501 may be shaped to have a pentagon-like shape and also to have a bend that mimics the bend at the apex of a roof of a structure.

With reference back to FIGS. 11A-C, some embodiments of the spot welding process may utilize one or more specialized seem welder, generally 700. The welder 700 includes opposing, coplanar, rotatable upper and lower welding wheels 362, 704 supported in position by parallel, rotatable, shafts 706, 708 respectively, which in turn are respectively supported by mating upper 713 and lower 715 bearings and driven by upper 710, 712 drive motors respectively. The same type of drive motor can be used as the upper 710 and lower 712 drive motor; one embodiment for such a motor is a model 6Z074B by Dayton. With these structures, simultaneous activation of the drive motors 710, 712, causes the welding wheels 362, 704 to rotate at the same rate of rotation.

In turn, the drive motors 710, 712 are mounted on parallel drive motor tables 714, 716 respectively. The lower drive table 716 is rigidly mounted in position in a support rack 700, and the upper drive table 714 is slidably mounted on two guide rods 718, 720 mounted laterally opposite each other from, and perpendicular to, the rotatable drive shafts 706, 708 and spaced laterally from plane of the welding wheels 702, 704 along the axis of the rotatable drive shafts 706, 708.

A jack support table 707 is mounted to the top 711 of the support rack 700 directly above the upper drive table 714. An upper end 723 of a scissors jack frame 722 of a scissor jack 725 is mounted to the lower surface of the upper end 709 of the jack support table 707. A lower scissors jack drive end 712 is connected to the upper drive motor table 714 to move the lower drive end 712 and upper drive table 714 upwardly and downwardly through a jack drive arm passageway 727 in the jack support table section under the control of the scissor jack 725, to allow movement of the upper drive motor table 714 upwardly and downwardly and adjust the vertical separation between the upper and lower welding wheels 362, 704 and their associated structures. This movement is controlled by a pneumatic drive 717 extending vertically between, and secured at opposing ends to, the upper end 723 and lower end 712 of the scissors jack 725

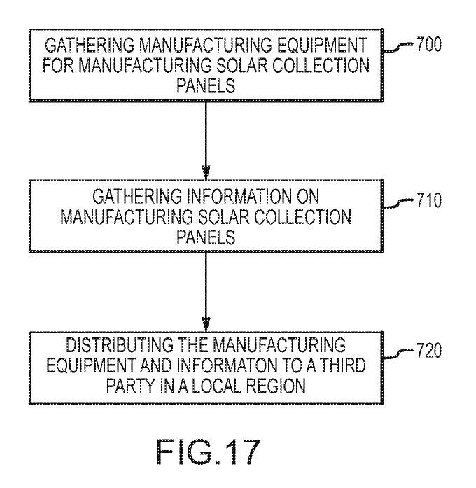

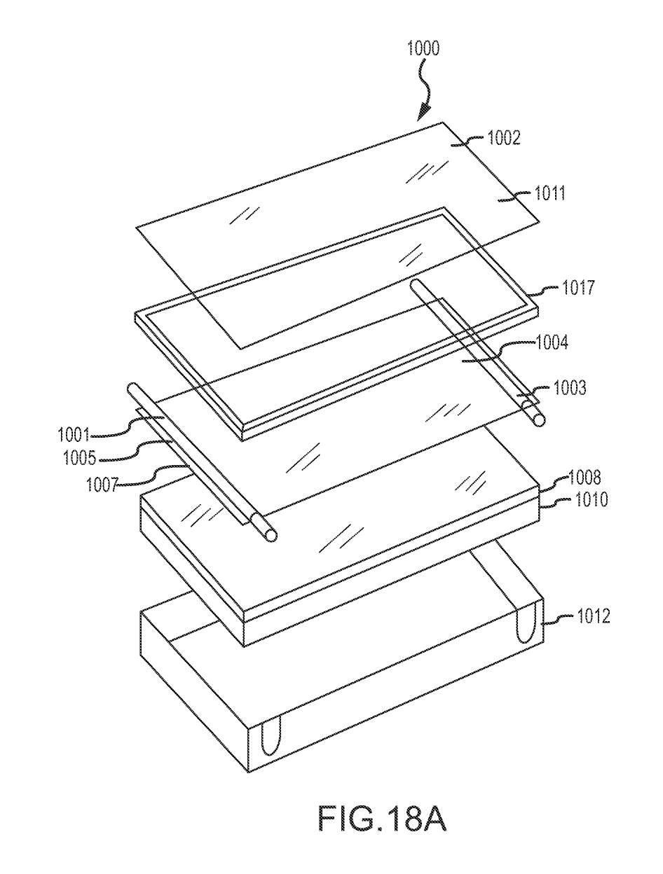

The welding wheels 362, 704 are made of a conductive material, such as copper or beryllium copper. Electrically conductive upper and lower plates (also called “brushes”) 724, 726 contact the upper and lower welding wheels 362, 704 respectively on the sides of the wheels 362, 704 facing their respective drive motors 710, 712. Each brush, e.g., 724, is mounted to contact its associated welding wheel, e.g., 362, adjacent the outer circumferential periphery of the wheel 702. The brushes 724, 726 are respectively connected to positive and negative terminals on a transformer which receives 120V input and delivers 1.5 volts and up to 2,200 amps at the contact point 730, 732 of the opposing welding wheels, 362, 704 respectively, when in use to create a seam weld in the stainless steal plates or sections (not shown in FIGS. 17A-D) passed between the welding wheels 362, 704 and thereby pressed together as desired by the predetermined separation between the welding wheels 702, 704. The side of the brushes, e.g., 724, slidably abutting the mating welding wheel 362 is coated (typically daily during use) with ultra fine graphite lubricant.

The seam welding structure shown in FIGS. 17 A-C can reduce damage to metal welded by the structure. For example, this type of seam welder can reduce or eliminating blowholes due to arcing between the welding wheels 362, 704 and reducing over heating, which can cause warping or decreased corrosion resistance in the welded metal.

The support structures in the seam welder, generally 700, are relatively non-conducing in order to reduce undesired magnetic flex or other interaction between components. Thus, the drive and support tables 707, 714, and 716 are made of relatively rigid plastic.

The seam welder 700 is 24″ square by 53″ high on the tracks, and weighs less than 200 lb. Uses only 110 V single phase power at under 20 amps. The seam welder 700 may be mounted on tracks 13″ apart made of 3″ angle iron with the angle up so “V” notched wheels mounted on the welder 700 can roll freely on them. Stops on both ends prevent the welder 700 from accidentally rolling off the end.

The seam welder 700 is thus compact but locates the welding wheels 362, 704 at a comfortable height for most adults to work with the welder 700. Wheels (not shown) can be mounted to the bottom of the seam welder 700.

In step 520, the assembled solar collection panel may then be installed on the structure at the location selected in step 500. The solar collection panel may be installed such that the second sheet of material of the solar collection panel faces away from the structure upon which the solar collection panel is mounted. In this manner, the dimples formed in the second sheet of material protrude towards the structure upon which the solar collection panel is mounted.

Installation of the solar collection panel on the structure may be by any suitable means that securely attaches the solar collection panel to the structure. The solar collection panel may be installed on the structure in such a manner that inclement weather, such as high winds, will not dislodge the solar collection panel from the structure. The solar collection panel may be permanently installed on the structure or installed on the structure in such a manner that the solar collection panel may be removed (e.g., such as when an owner moves from the structure or when the roof of a structure upon which a solar collection panel is mounted requires repair). Installation of the solar collection panel may include the use of a mounting bracket to mount the solar collection panel to the structure. Alternatively, the solar collection panel may be mounted or adhered directly to the structure. Installation may also include connecting the solar collection panel to a solar heating system such as the one described above.

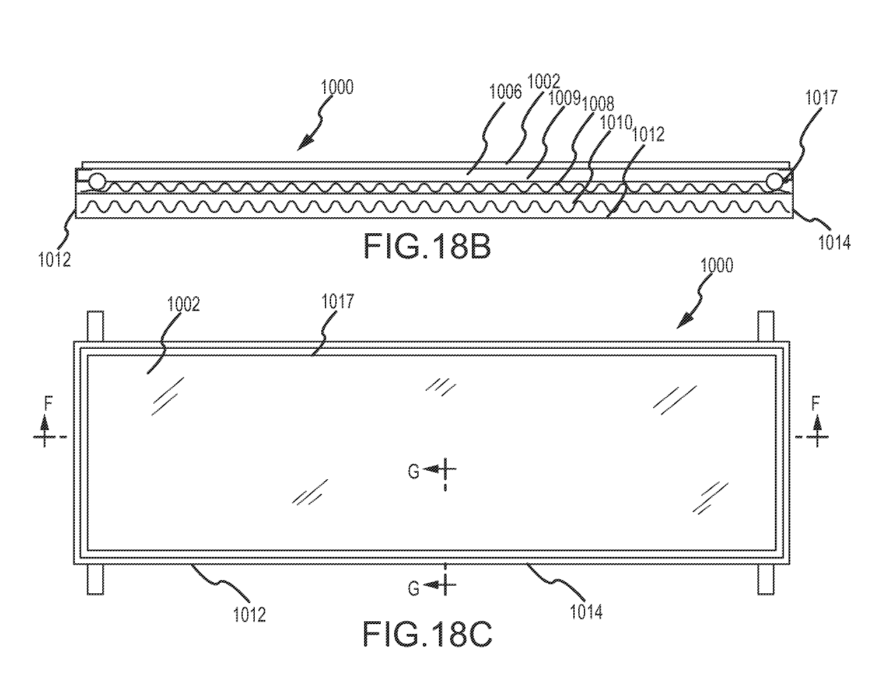

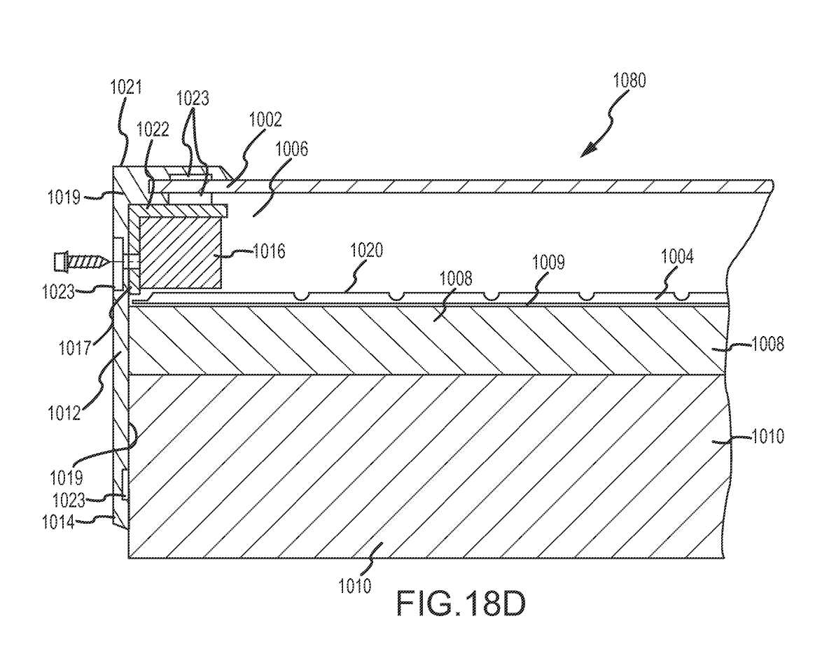

With reference now to FIGS. 18A-C, one embodiment of a framed solar collection panel 1000 can be mounted on adjacent or underlying structure (not shown) such as a roof or wall. The framed solar collection panel assembly 1000 may be rectangular or have any of many other desired shapes.

The framed solar collection panel 1000 includes parallel layers of: (i) tempered glass 1002 mounted to face toward solar source of energy, (ii) a solar collector envelope 1004 (with integral fluid headers 1001, 1003 formed in and by the opposing edge sections in opposing envelope sides, e.g., 1005, 1007) spaced from the tempered glass 1002 on the side of the glass 1002 opposite its solar energy receiving side 1011, (iii) an air space 1006 between the tempered glass 1002 and solar collector envelop 1004, (iv) fiber glass insulation 1008 with its foil face 1009 abutting the side of the solar collector envelope 1004 opposite the tempered glass 1002; and (v) foam insulation 1010 abutting the side of the fiber glass insulation 1008 opposite the solar collector envelope 1004. Each of these layers 1002, 1004, 1006, 1008, 1010 are mounted within a frame structure 1012 having a rectangular wood outer periphery 1014 and, in some embodiments (not shown) wood bottom 1015. An angle iron frame 1017 abuts the interior 1019 of the rectangular wood outer periphery 1014, held in position by fasteners, e.g., 1021, penetrating the wooden outer periphery 1014 and the angle iron frame 1017. Wood blocks 1016 glued to associated angle irons, e.g., 1017, in turn abuts the upper surface 1020 of the solar collector envelope 1004 along its outer edges within the frame structure 1012. The upper side 1022 of the angle iron 1017, in conjunction with a an outer trim 1019, support the tempered glass 1002 in position adjacent a wood lip 1019 extending inwardly from the rectangular wood periphery 1014. The tempered glass 1002 can be held in position with an adhesive sealer, e.g., 1023, between the glass 1002 and abutting trim lip 1021 and between the glass 1002 and abutting angle iron, e.g., 1017. Pressure generated during assembly by the compressed fiber class insulation 1008 and foam insulation 1010 (which may include, for example, isscanurate, Styrofoam, or other insulating material that will not generate substantial amounts of gas or vapor when heated in the environment of use of the solar panel 1000) against the other underlying structure, such a roof or other support for example, helps to locate the others structures in their desired locations with respect to each other during assembly.

The resulting solar collection panel 1000 can be particularly weather proof and efficient at collecting solar energy and preventing energy collected by the panel 1000 from being dissipated back to the ambient environment. It can be particularly economical to manufacture as well as easy to maintain and, for example, clean. It can also be relatively light weight and aesthetically attractive. It should be understood that this structure is only exemplary, and many changes could be made to the various components. For example, the frame structure 1012 and its components may be made of imitation wood (such as for example with lumber made of recycled plastic in whole or in part) or any number of others types of materials, fasteners, etc.

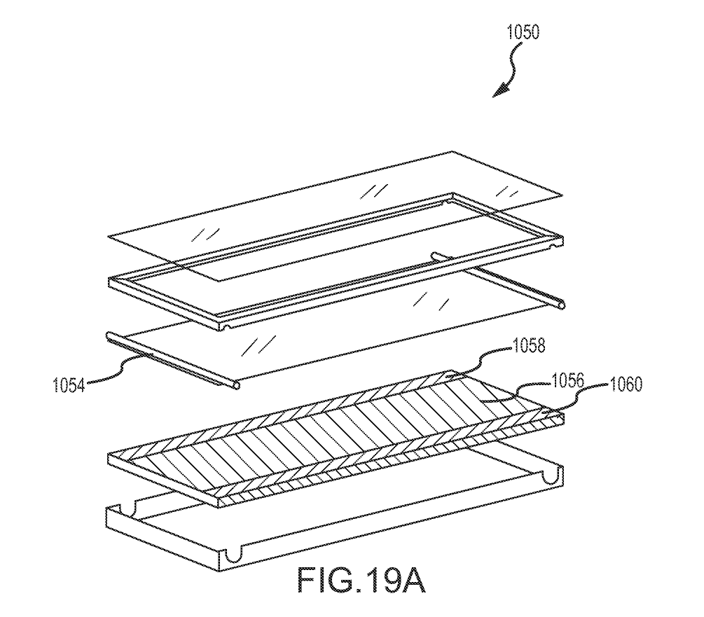

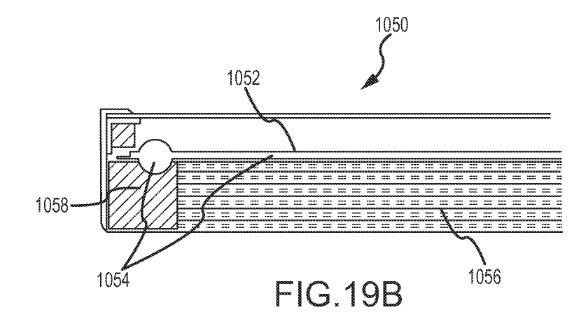

With reference now to FIGS. 19A and 19B, an alternative solar collection panel assembly, generally 1050, has differing structure underlying the integrated solar collection envelope/manifolds 1052 (see, e.g., integrated manifold 1054 and cooperatively formed integral heat transfer envelope/manifold fluid chamber 1054). This differing structure includes an insulator 1056, such as fiber glass as but one of many possible such insulators, that does not yield substantial off-gas in the environment of use of the assembly 1050. The insulator 1056 is mounted intermediate to laterally opposed relatively rigid and supporting sections 1058, 1060. The laterally supporting sections may be made of foam glass for example.

In some embodiments, the solar collector envelope with an internal manifold is so open to flow that a bank solar collectors performs like a single pipe with extremely large cross section for flow of collector fluid, such as water or anti-freeze. The envelopes with manifolds can also drain rapidly and completely.

Such envelopes can also be more efficient in collecting heat in the normal operating range and more capable of dumping excess heat when operating over 200 degrees F. This can solve or at least diminish overheating problems encountered by other collector systems.

Such envelopes can also be more efficient in collecting heat that colors can be used and still be among the most effective solar collectors available (when compared with other collectors as to BTU s/square foot/day). An envelope can also be used with the fittings attached to the back of the collector envelope to allow for shapes of collectors other than rectangle. This can be important in connection with appearance issues of structures where solar panels are applied.

Such envelopes can be very effective heat exchangers inside or outside of tanks for the same reason they are effective heat exchangers in a collector. One such reason is that they can have large solar collection and heat transfer surface areas.

The panel assembly structure is also flexible to adapt to differing solar collector panel or envelope shapes. The is structure can also be easily adapted to mount at a wide variety of angles to other structure. Silver brazing can seal joints or manifolds.

In the alternative panel assembly 1050 provides a particularly effective sealing structure that both prevents moisture from entering the assembly fogging up the inside of the glass and prevents internal components from generating off-gas that can contribute to reducing the amount of light reaching the associated solar pane envelope.

In step 530, the color of the solar collection panel may be changed. Solar collection panels such as those described above often are assembled using materials that are not altered from their natural color. For example, when sheets of stainless steel are used in the solar collection panel, portions of the solar collection panel will have the same gray color as the stainless steel sheets. Furthermore, when the solar collection panel includes a housing in which the two sheets of material are disposed, the top of the housing (i.e., the portion facing the sky) is often a black sheet of material. When the colors of these elements of the solar collection panel are not altered, the solar collection panel will not blend into the structure upon which it is mounted if the structure is not black or gray. Correspondingly, owners of the structures may be less willing to install the solar collection panels because of the negative effect the solar collection panels have on the aesthetics of the structure.

Accordingly, step 530 may include changing the color of the solar collection panels. The solar collection panel may be changed to a color which matches the color of the structure upon which the solar collection panel is mounted. Any manner of changing the color of the solar collection panel may be used, such as painting or dyeing the solar collection panel. Any type of paint, including commercially available paints such as Glidden™, Behr™, and Benjamin Moore™, may be used. Any color may be selected, including red, orange, yellow, green, blue, indigo and violet or any shades thereof. In one aspect, the solar collection panel may be colored in dark shades. The color used may also be a flat color, as opposed to one that leaves a shiny finish. The color of the solar collection panel may be uniformly changed using one color, or multiple colors may be used. For example, the trim of the solar collection panel may be changed to a color matching the trim of the structure upon which the solar collection panel is installed, while changing the color of the main portions of the solar collection panel to the same color as the main portions of the structure upon which the solar collection panel is mounted. Such a pattern may help the solar collection panel to blend in with the structure upon which the solar collection panel is installed.

In one aspect, the color of the second sheet of material is changed. As noted above, where the second sheet of material comprises stainless steel, the second sheet of material will be gray, and therefore step 530 may comprise changing the color of the second sheet of material to a color other than gray. As noted above, any manner of changing the color of the second sheet of material may be used, such as painting or dyeing.

Step 530 need not be performed as the last step of the method recited in the fourth embodiment Changing the color of the solar collection panel may be performed prior to assembling the solar collection panel. For example, the color of the component pieces of the solar collection panel, such as the second sheet of material, may be changed prior to assembling the solar collection panel. Alternatively, the color of the solar collection panel or components of the solar collection panel may be changed after the solar collection panel is assembled but prior to installing the solar collection panel on the structure.

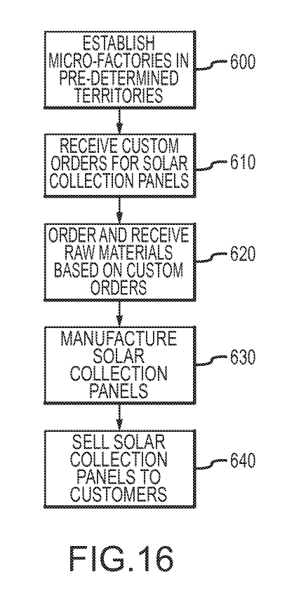

A sixth embodiment of the instant disclosure relates to a method of providing systems for manufacturing, using, distributing, or selling or leasing solar heat exchange systems and related products and services. FIG. 16 illustrates a flow diagram of the method of the sixth embodiment.

Solar heat exchange systems may include, but are not limited to, solar fluid heating systems such as solar water heating systems. Solar heat exchange systems may include components including, but limited to, solar collection panels, heat exchangers, and tanks with heat exchanger walls. The solar collection panels, heat exchangers and tanks with heat exchanger walls that may comprise the solar fluid heating system or a component of a solar fluid heating system may be similar or identical to the solar collection panels, heat exchangers and tanks with heat exchangers described in greater detail above.

In a step 600, one or more micro-factories may be provided by a provider, including by distribution, sale, or lease of the one or more micro-factories (or facilities for establishing a micro-factory) to a third party, with one or more of the micro-factories being equipped to manufacture, install, use, distribute, lease, or sell solar heat exchange systems. Any type of solar heat exchange system may be manufactured by the micro-factories and therefore the equipment used in the micro-factories to manufacture solar heat exchange systems may be any type necessary to carry out the manufacturing method. In an alternate aspect, the micro-factories may be set up to also manufacture other solar power equipment, or even non-solar power equipment.

In one aspect, the solar heat exchange systems manufactured at the micro-factory comprise components of the type described above in the third and fourth embodiments and the equipment provided by the provider for use in the micro-factories may be of the type needed to perform the manufacturing steps discussed above (e.g., dimpler, crimper, spot welder, etc.).

Establishing each micro-factory may comprise providing facilities for building and operating a new factory or leasing or buying existing space that may be adapted to manufacturing solar heat exchange systems or other equipment. Whether the micro-factory is built from scratch or, an existing space is used may depend upon the territory where the micro-factory is established. Each micro-factory need not be established in the same manner, and the method described herein may comprise micro-factories established in different manners. In some embodiments, however, the micro-factory facilities as provided by the provider are generally the same, and in this fashion economies of scale may be attained in providing such facilities.

Each micro-factory may be established in a pre-determined territory. The size of the pre-determined territory is not limited, although the micro-factory should be able to handle orders from all customers within the pre-determined territory. If a micro-factory is not capable of handling all of the orders from the customers within the pre-determined territory, a new micro-factory may be provided, and the pre-determined territories may be re-established to ensure all customers may be accommodated. If a micro-factory is not operating at close to capacity, the pre-determined territory for that micro-factory may be enlarged.

In one example, the pre-determined territory may be a county or state. In one aspect, each micro-factory may service only customers from within the pre-determined territory. If an order is received at a micro-factory from a customer outside of the micro-factory's pre-determined territory, the micro-factory may refer the customer to the appropriate micro-factory servicing that customer's region. The micro-factory may also take the order and subsequently transfer it to the appropriate micro-factory for call back and follow-up.

In a next step 610, each of the one or more micro-factories may receive or be adapted to receive custom orders for solar heat exchange systems. The custom orders may come from customers within the micro-factory's pre-determined territory. The micro-factories may receive the custom orders in any suitable manner, including by phone, by mail, in person, or orders placed over the Internet.

The micro-factories may receive predominantly custom orders, meaning the micro-factories may keep on hand few to no assembled components of a solar heat exchange system that have not specifically been ordered. In this manner, the micro-factory may reduce costs by eliminating the need for storage space. Orders may comprise orders for standard solar heat exchange system components or special orders for non-standard solar heat exchange system components tailored to the specific needs of the customer.

In an alternate aspect, the micro-factories may store assembled solar heat exchange system components. In this manner, the micro-factory may be able to provide customers seeking standard solar heat exchange systems or solar heat exchange system components quicker delivery time and more responsive support from the local micro-factory. In addition, delivery from the local micro-factory can reduce costs of shipping, etc., from other more distant locations.

In a next step 620, a micro-factory may order and receive raw materials for manufacturing solar heat exchange systems once an order has been placed by a customer within the micro-factory's pre-determined territory. The micro-factory may keep very little to no raw materials on hand in the micro-factory unless the raw material is for fulfilling a specific custom order. The micro-factory may also purchase raw material in rolls that can be cut to order without waste. In this manner, the micro-factory may reduce cost by eliminating the need for storage space.

All of the micro-factories may order raw materials from the same raw materials sources. For example, micro-factories in three different pre-determined territories may order stainless steel from the same raw material supplier. The raw material supplier may be within or outside of any of the micro-factory pre-determined territories. In this manner, the micro-factories may take advantage of bulk discounted rates despite each micro-factory individually not qualifying for a bulk discounted rate on raw materials.

Alternatively or in conjunction with using the same raw material supplier, each micro-factory may order certain raw materials from a local raw material supplier. In this manner, micro-factories with local ties to local raw material suppliers may take advantage of better prices that may be offered by a local distributor rather than being tied to a nationwide raw material supplier.

In a next step 630, each of the micro-factories may manufacture the custom ordered solar heat exchange systems. Manufacturing of the solar heat exchange systems may be by a standard manufacturing method used by most or all of the micro-factories, or may be by a new method developed by the specific micro-factory. The micro-factories may be encouraged to innovate and develop new manufacturing techniques that, if successful, may be adopted by all of the micro-factories and thereby improve the overall performance of the micro-factories as a collective whole.

The micro-factories may be operated part of the day or the entire day in order to complete the manufacture of all of the solar heat exchange systems ordered by customers. The micro-factories may be run in shifts, with more shifts being added should orders increase beyond capacity of the number of existing shifts. In this manner, the micro factories may adapt to an unforeseen change in demand.

In a next step 640, the custom-ordered solar heat exchange systems may be sold to the customer within the pre-determined territory that ordered the system. Alternatively, where a solar heat exchange system is manufactured but the customer changes his or her mind, the manufactured solar heat exchange system may be sold to another customer should one exist. In this manner, the micro-factory may mitigate lost profits and continue to minimize, storage needs.

Micro-factories may also replace or repair faulty solar heat exchange systems or components of solar heat exchange systems to thereby provide superior factory service.

A seventh embodiment disclosed herein relates to a method of distributing solar heat exchange systems manufacturing facilities. FIG. 17 illustrates a flow diagram of the method.

Solar heat exchange systems may include, but are not limited to, solar fluid heating systems such as solar water heating systems. Solar heat exchange systems may includes components including, but limited to, solar collection panels, heat exchangers, and tanks with heat exchanger walls. The solar collection panels, heat exchangers and tanks with heat exchanger walls that may comprise the solar fluid heating system or a component of a solar fluid heating system may be similar or identical to the solar collection panels, heat exchangers and tanks with heat exchangers described in greater detail above.

In a first step 700, manufacturing equipment for manufacturing solar heat exchange systems may be gathered. The manufacturing equipment gathered may be any type of manufacturing equipment needed to manufacture the type of solar heat exchange system to be manufactured. The step of gathering manufacturing equipment may comprise gathering every piece of equipment needed to manufacture a solar heat exchange system, gathering some but not all of the equipment needed to manufacture a solar heat exchange system, or gathering a single piece of equipment needed to manufacture a solar heat exchange system.

Gathering the equipment may be by any suitable means, including but not limited to, obtaining the equipment from a commercial retailer, obtaining the equipment from the manufacturer of the equipment, or building the manufacturing equipment. Each piece of equipment need not be gathered by the same means.

In one example, the equipment gathered may be the equipment necessary to carry out the method described above in the third embodiment. Accordingly, the equipment gathered may include a dimpler for forming one or more dimples in a sheet of material, a crimper for crimping the edges of a sheet of material, a spot welder for spot welding the sheets of material together at the dimples, and a seam welder for seam welding the edges of the sheets of material. The equipment may also include a form mold for forming manifolds in the solar collection panel. The equipment gathered may be any suitable type, brand, or size of equipment. The type and size of these pieces of equipment may depend on factors such as the size of solar collection panels to be manufactured and the speed at which the solar collection panels are to be manufactured. In other examples, the equipment gathered may be the equipment necessary to manufacture the heat exchangers and tanks with heat exchanger walls described in greater detail above.

Specialized equipment that may be gathered includes, but is not limited to, tables, dimplers, crimpers, sequential spot welders, feed mechanisms, manifold formers, heat exchanger formers, tank formers, seam welders, clamping jigs, and pressure test setups. Standard equipment that may be gathered includes, but is not limited to, sets of glass suction cups, 52 inch shears, 96 inch shears, portable 110 volt spot welders (air cooled), stationary 220 volt spot welders (water cooled), oxyacetalene torches, power cut off saws, band saws for metal cutting, MIG welders, TIG welders, plasma cutters, lathe, drill press, grinders, belt sanders, fork lifts, storage racks, metal breaks, box breaks, hole punches with arbor press, air compressors, strapping tools, spray booths and spray equipment, 6 foot bending roll, drills, vises, clamps, welding helmets, tool boxes, taps, and dies.

A next step 710 may comprise gathering information on the manufacture of solar heat exchange systems using the manufacturing equipment. The information gathered may be related to any aspect of manufacturing solar heat exchange systems, including but not limited to, assembling manufacturing equipment, constructing an assembly line of manufacturing equipment, performing the manufacturing method, maintaining the manufacturing equipment, and performing quality control on the manufactured solar heat exchange systems. The information may also include information on marketing, installing, or selling the manufactured solar heat exchange systems.

Other information that may be gathered includes, but is not limited to, technical support, training for new hires, training for third parties, design of shop space to provide proper manufacture flow, electrical supply, compressed air supply, and quality control systems.

Gathering the information on the manufacture of solar heat exchange systems may be by any suitable means. The information may be gathered from the commercial retailer from which the equipment was gathered or the manufacturer of the equipment from which the equipment was gathered. Information may also be gathered from the party to be distributing the equipment and information. Information may also be gathered from the Internet. The information may be gathered from a variety of different sources or from a single source. The gathered information may be gathered in any suitable format. For example, information may be gathered in written, audio, or visual formats.

In a next step 720, the equipment and information may be distributed to a third party assigned to a local region. The equipment and information may be distributed by any suitable means, including but not limited to, selling, leasing or renting the equipment and information. The method of distributing the equipment need not be the same method of distributing the information. Means of physically distributing the equipment and information is also not limited. Equipment and information may be shipped to the third party, or the third party may be responsible for picking up the equipment and information. In the case of the information, distribution may also be by electronic transmission, such as by facsimile or electronic mail. The equipment, need not be physically distributed in the same manner as the information.

The third party may be any type of third party. The third party may be, for example, an individual, a group of individuals, or a corporation. In one example, the third party is a home builder, plumbing contractor, or machine shop owner.

The third party may be assigned to a local region. The local region may be the region in which the third party manufactures and sells solar heat exchange systems manufactured using the distributed equipment and information. The third party may be located in the local region or may be located outside of the local region. The size of the local region is not limited and may relate to the estimated demand for solar heat exchange systems in the region or to the population in the region. The local region may be, for example, a township, a county, or a state. The local region need not be defined by government-established boundaries.

Distributing the equipment and information may further comprise providing the third party with exclusivity within its local region. Exclusivity may include an agreement not to distribute equipment and information to another party in the third party's local region or to distribute equipment and information to another party that plans to sell solar heat exchange systems within the third party's assigned local region. The exclusivity may also include an agreement not to distribute equipment and information to another party in other local regions. Conversely, distributing the equipment and information may include an agreement that the third party will not sell solar heat exchange systems or components thereof manufactured using the distributed equipment and information outside of their assigned local region or outside a group of local regions.

The method described herein may further comprise a step of selling raw materials to the third party. The raw materials may be any raw materials necessary to manufacture solar heat exchange systems using the distributed equipment and information. All or some of the raw materials necessary to manufacture solar heat exchange systems using the distributed equipment and information may be sold to the third party. Raw material may be continuously sold to the third party or may be sold on a periodic basis. Raw material sold to the third party may include stainless steel, steel, copper, aluminum, insulation, glass, paint, copper pipe, brazing alloy, flux, and adhesives.

The method described herein may further comprise a step of consulting with the third party after the equipment and information has been distributed. Any type of consulting may be provided to the third party. Consulting may be in regards to operating the distributed manufacturing equipment. Consulting may be in regards to marketing and selling manufactured solar heat exchange systems or quality control. Consulting need not be in regards to solar heat exchange systems. For example, consulting may be in regards to human resources issues, such as hiring employees to operate the distributed equipment.

Other consultation topics that may be discussed with the third party include, but are not limited to, creating synergy between micro-factories and promoting innovation within the individual micro-factories.

While certain embodiments and details have been included herein for purposes of illustrating aspects of the instant disclosure, it will be apparent to those skilled in the art that various changes in systems, apparatus, and methods disclosed herein may be made without departing from the scope of the instant disclosure, which is defined, in part, in the appended claims. The words “including” and “having,” as, used herein including the claims, shall have the same meaning as the word “comprising.”

What is claimed is:

1. A solar heating system comprising:
a solar collection panel having a first end and a second end opposite the first end;
a fluid-containment vessel, the fluid-containment vessel comprising:
an inner surface;
an outer surface opposite the inner surface;
a heat exchanger wall, the heat exchanger wall comprising:
a first end;
a second end opposite the first end;
peripheral edges; and
a central portion surrounded by the peripheral edges;
wherein the peripheral edges are secured to the outer surface of the fluid-containment vessel and the central portion projects away from the outer surface of the fluid-containment vessel to thereby create a heat exchange fluid cavity between the outer surface of the fluid-containment vessel and the heat exchanger wall; and
wherein the central portion of the heat exchanger wall comprises one or more dimples extending towards the outer surface of the fluid-containment vessel;
a first set of piping extending between the second end of the solar collection panel and the first end of the heat exchanger wall and providing fluid communication between the solar collection panel and the heat exchanger wall;
a second set of piping extending between a second end of the heat exchanger wall and the first end of the solar collection panel and providing fluid communication between the heat exchange wall and the solar collection panel; and
propylene glycol circulating through the solar heating system, including the solar collection panel, the first set of piping, the second set of piping, and the heat exchanger wall.

2. The solar heating system as recited in claim 1, wherein the solar collection panel comprises:
a first sheet of material comprising first peripheral edges; and
a second sheet of material opposite the first sheet of material and separated from the first sheet of material by a predetermined distance, the second sheet of material comprising second peripheral edges and a central portion surrounded by the second peripheral edges;
wherein the second peripheral edges of the second sheet of material are secured to the first peripheral edges to thereby create a void space between the first sheet of material and the second sheet of material; and
wherein the second sheet of material further comprises one or more dimples extending towards and resistance welded to the first sheet of material.

3. The solar heating system as recited in claim 2, wherein the first sheet of material and second sheet of material comprise steel or stainless steel.

4. A storage tank, comprising:
a single-walled fluid-containment vessel, wherein the single-walled fluid containment vessel comprises an inner surface and an outer surface opposite the inner surface; and
one or more heat exchanger walls, wherein the one or more heat exchanger walls each comprise peripheral edges and a central portion surrounded by the peripheral edges;
wherein the peripheral edges of each of the one or more heat exchanger walls are resistance welded to the outer surface of the single-walled fluid containment vessel and the central portion of each of the one or more heat exchanger walls projects away from the outer surface of the single-walled fluid containment vessel to thereby create a heat exchange fluid cavity between the outer surface of the single-walled fluid containment vessel and each of the one or more heat exchanger walls; and
wherein the central portion of each of the one or more heat exchanger walls further comprises a plurality of dimples extending towards the outer surface of the single-walled fluid containment vessel.

5. The storage tank of claim 4, wherein the plurality of dimples contact the outer surface of the single-walled fluid containment vessel at a contact point and are resistance welded to the outer surface of the single-walled fluid containment vessel at the contact points.

6. The storage tank of claim 4, wherein the single-walled containment vessel has a cylindrical shape.

7. The storage tank of claim 4, wherein the one or more heat exchanger walls each comprise an inlet port and an outlet port for introducing and removing a heat exchange fluid from the heat exchange fluid cavity.

8. The storage tank of claim 4, wherein the one or more heat exchanger walls comprise a material selected from the group consisting of steel and stainless steel.

9. A method of constructing a solar collection panel, the method comprising the steps of:
providing a first sheet of material having a first side, a second side opposite the first side, a first end, a second end opposite the first end, and a central portion surrounded by the first side, second side, first end and second end;
forming one or more dimples in the central portion of the first sheet of material;
providing a second sheet of material having a first side edge, a second side edge opposite the first side edge, a first end, and a second end opposite the first end;
crimping the first side and the second side of the second sheet of material to thereby create a second sheet of material having a valley between the first and second crimped sides:
aligning the first sheet of material with the second sheet of material such that the one or more dimples in the first sheet of material protrude into the valley of the second sheet of material and the crimped first and second sides of the second sheet of material contact the first side and second side of the first sheet of material, respectively;
spot welding the one or more dimples in the first sheet of material to the valley of the second sheet of material;
seam welding the first side of the first sheet of material to the first side of the second sheet of material and seam welding the second side of the first sheet of material to the second side of the second sheet of material;
form molding the first end of the first sheet of material and the first end of the second sheet of material to form a first manifold and form molding the second end of the first sheet of material and the second end of the second end of the material to form a second manifold; and
seam welding the first end of the first sheet of material to the first end of the second sheet of material and seam welding the second end of the first sheet of material to the second end of the second sheet of material.

10. The method of claim 9, wherein the spot welding and seam welding steps comprise resistance welding.

11. The method of claim 9, wherein the first sheet of material and the second sheet of material comprise steel, stainless steel, aluminum, or copper.

12. The method of claim 9, wherein spot welding comprises simultaneously spot welding more than one dimple to in the first sheet of material to the valley of the second sheet of material.

13. A solar collection panel manufactured by a method comprising the steps of:
providing a first sheet of material having a first side, a second side opposite the first side, a first end, a second end opposite the first end, and a central portion surrounded by the first side, second side, first end and second end;
forming one or more dimples in the central portion of the first sheet of material;
providing a second sheet of material having a first side edge, a second side edge opposite the first side edge, a first end, and a second end opposite the first end;
crimping the first side and the second side of the second sheet of material to thereby create a second sheet of material having a valley between the first and second crimped sides;
aligning the first sheet of material with the second sheet of material such that the one or more dimples in the first sheet of material protrude into the valley of the second sheet of material and the crimped first and second sides of the second sheet of material contact the first side and second side of the first sheet of material, respectively;
resistance spot welding the one or more dimples in the first sheet of material to the valley of the second sheet of material;
resistance seam welding the first side of the first sheet of material to the first side of the second sheet of material and seam welding the second side of the first sheet of material to the second side of the second sheet of material;
form molding the first end of the first sheet of material and the first end of the second sheet of material to form a first manifold and form molding the second end of the first sheet of material and the second end of the second end of the material to form a second manifold; and
resistance seam welding the first end of the first sheet of material to the first end of the second sheet of material and seam welding the second end of the first sheet of material to the second end of the second sheet of material.

14. The solar collection panel of claim 13, wherein the first sheet of material and the second sheet of material comprise steel or stainless steel.

15. A method of installing a solar collection panel on a structure comprising the steps of:
selecting a location on a structure to erect a solar collection panel;
assembling the solar collection panel, the solar collection panel comprising:
a first sheet of material having peripheral edges and a central portion surrounded by the peripheral edges, wherein the central portion protrudes below the peripheral edges to create a valley in the first sheet of material; and
a second sheet of material having peripheral edges and a central portion surrounded by the peripheral edges, wherein the central portion comprises one or more dimples;
wherein the peripheral edges of the first sheet of material are aligned with the peripheral edges of the second sheet of material such that the dimples in the second sheet of material extend into the valley in the first sheet of material;
installing the solar collection panel on the structure such that the second sheet of material faces away from the structure; and
changing the color of the second sheet of material of the solar collection panel.

16. The method as claimed in claim 28, wherein the solar collection panel is non-rectilinear.

17. The method as claimed in claim 15, wherein the step of changing the color of the second sheet of material of the solar collection panel occurs prior to the step installing the solar collection panel on the structure or prior to the step of assembling the solar collection panel.

18. A method of manufacturing and selling solar heat exchange systems, the method comprising the steps of:
establishing one or more micro-factories equipped to manufacture and sell solar heat exchange systems, wherein each micro-factory services only customers residing within a pre-determined territory;
each of the one or more micro-factories receiving custom orders for solar heat exchange systems from customers within each micro-factory's pre-determined territory;
each of the one or more micro-factories ordering and receiving raw materials for the custom-ordered solar heat exchange systems from an identical raw materials supply source;
each of the one or more micro-factories manufacturing the custom-ordered solar heat exchange systems; and
each of the one or more micro-factories selling the custom-ordered solar heat exchange systems to the customers residing within its pre-determined territory.

19. A method of distributing solar heat exchange system manufacturing facilities, the distributing method comprising in combination:
gathering manufacturing equipment for manufacturing solar heat exchange systems, wherein the manufacturing equipment comprises:
a dimpler;
a crimper;
a spot welder;
a seam welder; and
a form mold;
gathering information on the manufacture of solar heat exchange systems using the manufacturing equipment; and
distributing the manufacturing equipment and information to a third party assigned to a local region.

20. The method of claim 19 further comprising in combination:
selling raw materials to the third party, wherein the raw materials comprise raw materials necessary to manufacture solar heat exchange systems.

21. The method of claim 19 further comprising in combination:
consulting with the third party regarding operating the manufacturing equipment and selling manufactured solar heat exchange systems.

22. The distributing method of claim 19 further comprising in combination:
providing the third party with exclusivity in its local region, the exclusivity including an agreement not to distribute manufacturing equipment and information to another party in the local region or another local region.

23. A solar collection panel enclosing a fluid flow chamber comprising:
a first side;
a second side spaced apart from the first side by the fluid flow chamber;
at least one support structure located in the fluid flow chamber and contacting both the first side and the second side; and
a first fluid flow channel located along a first edge of the solar collection panel and in fluid communication with the fluid flow chamber.

24. The solar collection panel of claim 23, wherein the at least one support structure is integrally formed with the first side, the second side, or both the first side and the second side.

25. The apparatus of claim 23, wherein the second side is aligned substantially parallel with the first side.

26. The apparatus of claim 23, wherein the height of the first fluid flow channel is greater than the first side is spaced apart from the second side.

27. The apparatus of claim 23, further comprising a second fluid flow chamber located along a second edge of the solar collection panel opposite the first edge of the solar collection panel and in fluid communication with the fluid flow chamber.
